(19) United States
(12) Patent Application Publication
(10) Pub. No.: US 2014/0250196 A1
(43) Pub. Date: Sep. 4, 2014

(54) APPARATUS AND METHOD FOR PROVIDING AND/OR FOR PROCESSING INFORMATION REGARDING, RELATING TO, OR INVOLVING, DEFAMATORY, DEROGATORY, HARRASSING, BULLYING, OR OTHER NEGATIVE OR OFFENSIVE, COMMENTS, STATEMENTS, OR POSTINGS

(71) Applicant: RAYMOND ANTHONY JOAO, YONKERS, NY (US)

(72) Inventor: RAYMOND ANTHONY JOAO, YONKERS, NY (US)

(21) Appl. No.: 14/166,629

(22) Filed: Jan. 28, 2014

Related U.S. Application Data
(60) Provisional application No. 61/851,093, filed on Mar. 1, 2013.

(51) Int. Cl. H04L 12/58; G06F 17/30

(52) U.S. Cl. CPC H04L 51/36; G06F 17/30864
USPC 709/206

(57) ABSTRACT

A computer-implemented method, including storing, in a memory device, information regarding a search request relating to an individual; processing, with a processing device or with a computer, information regarding the search request; performing a search of the Internet or the World Wide Web using the search request; receiving search results obtained from search; generating a search report containing results obtained from the search, wherein the search report contains information regarding at least one comment, statement, or posting, which contains a defamatory, a derogatory, a harassing, a bullying, or other negative or offensive, comment, statement, or posting, about or regarding the individual; generating a notification message; and transmitting the notification message to a communication device associated with the individual.

### RELATED APPLICATIONS

This application claims the benefit of the priority of U.S. Provisional Patent Application Ser. No. 61/851,093, filed Mar. 1, 2013, and entitled “APPARATUS AND METHOD FOR PROVIDING AND/OR FOR PROCESSING INFORMATION REGARDING, RELATING TO, OR INVOLVING, DEFAMATORY, DEROGATORY, HARRASSING, BULLYING, OR OTHER NEGATIVE OR OFFENSIVE, COMMENTS, STATEMENTS, OR POSTINGS”, the subject matter and teachings of which are hereby incorporated by reference herein in their entirety.

### FIELD OF THE INVENTION

The present invention pertains to an apparatus and method for providing and/or for processing information regarding, relating to, or involving, defamatory, derogatory, harassing, bullying, or other negative or offensive, comments, statements, or postings, and, in particular, the present invention pertains to an apparatus and method for providing and/or for processing information regarding, relating to, or involving, defamatory, derogatory, harassing, bullying, or other negative or offensive, comments, statements, or postings, made, disseminated, or posted on or via the Internet and/or the World Wide Web, which can detect same, which can provide notification of same, which can allow an individual or entity to respond to same and/or to have same removed or expunged from the medium on which same appears or from which same is disseminated, and/or which allow can an individual or entity to seek legal recourse against the people or entities who engage in such conduct.

### BACKGROUND OF THE INVENTION

While the Internet and/or the World Wide Web is a valuable and widely used communication platform, network, and/or medium, which provides the millions and millions of individuals and entities who or which utilize same with numerous benefits and advantages, the Internet and World Wide Web can be, and has been, misused by individuals and entities who or which make, post, and/or otherwise disseminate, defamatory, derogatory, harassing, bullying, or other negative or offensive, comments, statements, or postings, about other individuals or entities.

Many individuals take advantage of, and misuse, the Internet and/or the World Wide Web in order to make, disseminate, or post, defamatory, slanderous, libelous, and otherwise false and/or misleading statements, comments, or postings, as well as derogatory, harassing, bullying, or other negative or offensive, comments, statements, or postings, about other individuals or entities. These comments, statements, or postings, once made, are hard to undo or to retract in the same way in which a bell, once rung, cannot be unrung.

As a result, individuals or entities who or which are the subject of these defamatory, slanderous, libelous, and otherwise false and/or misleading statements, comments, or postings, derogatory, harassing, bullying, or other negative or offensive, comments, statements, or postings, have to either live with, or deal with, same. These defamatory, slanderous, libelous, and otherwise false and/or misleading statements, comments, or postings, derogatory, harassing, bullying, or other negative or offensive, comments, statements, or postings, can remain in the public domain indefinitely in one form or another, or can migrate from one medium or website in an uncontrollable or unfettered manner.

Unfortunately, the nature of the Internet and/or the World Wide Web makes it difficult to have these comments, statements, or postings, removed or expunged as the individuals who make, disseminate, or post, same can easily re-post same or can post same on other websites, making it virtually impossible for any individual or entity to effectively and efficiently deal with same.

As a result, individuals or entities must either deal with, or live with, these defamatory, slanderous, libelous, and otherwise false and/or misleading statements, comments, or postings, and/or derogatory, harassing, bullying, or other negative or offensive, comments, statements, or postings, or expend great time and resources to deal with same, while the individuals who make, disseminate, or post, same are free to do so, and are free to continue to do so, with impunity.

### SUMMARY OF THE INVENTION

The present invention pertains to an apparatus and method for providing and/or for processing information regarding, relating to, or involving, defamatory, derogatory, harassing, bullying, or other negative or offensive, comments, statements, or postings, which overcomes the shortcomings of the prior art.

The present invention can be utilized in a number of preferred embodiments in order to notify users, individuals, members, subscribers, or entities, when comments, statements, or postings, which name them and which contain defamatory, derogatory, harassing, bullying, or other negative or offensive, comments, statements, or postings, regarding them are detected on the Internet and/or the World Wide Web, and provides the respective users, individuals, members, subscribers, or entities, with the ability to respond to same, to counter same, to have same removed, deleted, or expunged, and/or to take measures to protect their reputations or the reputations of others.

The apparatus of the present invention includes a central processing computer which can perform any of the processing routines and functionality described herein as being performed by the apparatus of the present invention. The central processing computer can be any computer, computer system, group of computers, server, server system, or group of servers which can be programmed and equipped to perform any of the herein-described functions, operations, or actions described herein as being performed by the central processing computer and the apparatus of the present invention. The central processing computer can include any needed or desired computers, processing devices, central processing devices, input devices, output devices, databases or memory devices and/or systems, random access memory (RAM) devices, read only memory (ROM) devices, receivers, transmitters, network interface devices, information or content gathering devices, and/or any other devices, equipments, or systems. Any number of central processing computers can be utilized in conjunction with the apparatus of the present invention.

The central processing computer or central processing computers described as being utilized in connection or in conjunction with the apparatus and method or the present invention can also be performed by or implemented using cloud computer hardware and/or software. In this regard, any and/or all of the central processing computers described herein can be implemented using a cloud computing architecture, server computers or network computers, and/or any cloud computing hardware and/or software.

The apparatus of the present invention can operate in connection with the Internet and/or the World Wide Web and/or any and/or all of the numerous computers, computer systems, server computers, websites, web hosting computers, web hosting services computers, and/or any other computers, devices, or entities, which are included in, or which operate on, via, or in connection with, the Internet and/or the World Wide Web. The central processing computer can be connected to and/or linked with the Internet and/or the World Wide Web. The central processing computer can also be linked with the Internet and/or the World Wide Web via a wireless communication network.

The apparatus of the present invention can also include a legal services provider computer or communication device (hereinafter “legal services provider computer”) which can be associated with or utilized by any law firm, lawyer, attorney, paralegal, law firm employee, or any other provider of legal services or employee or other person associated with same, who or which can utilize, or which can be involved in the utilization of, the apparatus of the present invention in order to provide legal services for any individuals, users, members, or subscribers, who or which utilize the apparatus and method of the present invention. The legal services provider computer can be any computer or computer system, or can be any personal computer, laptop computer, notebook computer, tablet computer, cellular telephone, personal digital assistant, wireless telephone, wireless communication device, personal communication device, personal communications services device, smart phone, mobile telephone, hand-held device or computer, palm-top device or computer, watch, telephone, television, interactive television, digital television, smart television or entertainment device, or any other suitable device, which can be utilized as a legal services provider computer, which can be utilized by any law firm, lawyer, attorney, paralegal, law firm employee, or any other provider of legal services or employee or other person associated with same who or which can utilize, or which can be involved in the utilization of, the apparatus of the present invention, or which can be equipped to perform the functions described herein as being performed by the legal services provider computer.

The legal services provider computer can include any needed or desired computers, processing devices, central processing devices, input devices, output devices, databases or memory devices and/or systems, random access memory (RAM) devices, read only memory (ROM) devices, receivers, transmitters, network interface devices, information or content gathering devices, and/or any other devices, equipments, or systems. Any number, types, or kinds, of legal services provider computers can be utilized in connection with the apparatus of the present invention. The central processing computer can be connected with and/or linked with the legal services provider computer. The legal services provider computer can also be linked with the central processing computer via a wireless communication network.

The central processing computer and the legal services provider computer can communicate with each other in a bi-directional manner. In this regard, the central processing computer can transmit signals, data, information, or messages to the legal services provider computer and can receive signals, data, information, or messages transmitted from the legal services provider computer.

The apparatus of the present invention can also include a law enforcement computer or communication device (hereinafter “law enforcement computer”) which can be associated with or utilized by any public or private law enforcement agency, bureau, department, company or entity, or which can be associated with or utilized by any individual associated with or employed by same, who or which can utilize the apparatus and method of the present invention.

The law enforcement computer can be any computer or computer system, or can be any personal computer, laptop computer, notebook computer, tablet computer, cellular telephone, personal digital assistant, wireless telephone, wireless communication device, personal communication device, personal communications services device, smart phone, mobile telephone, hand-held device or computer, palm-top device or computer, watch, telephone, television, interactive television, digital television, smart television or entertainment device, or any other suitable device, which can be utilized as a law enforcement computer, which can be utilized by any public or private law enforcement agency, bureau, department, company or entity, or by any individual associated with or employed by same, which can utilize, or which can be involved in the utilization of, the apparatus and method of the present invention, or which can be equipped to perform the functions described herein as being performed by the law enforcement computer.

The law enforcement computer can include any needed or desired computers, processing devices, central processing devices, input devices, output devices, databases or memory devices and/or systems, random access memory (RAM) devices, read only memory (ROM) devices, receivers, transmitters, network interface devices, information or content gathering devices, and/or any other devices, equipments, or systems. In a preferred embodiment, any number, types, or kinds, of law enforcement computers can be utilized in connection with the apparatus of the present invention. The central processing computer can be connected with and/or linked with the law enforcement computer. The law enforcement computer can also be linked with the central processing computer via a wireless communication network.

The central processing computer and the law enforcement computer can communicate with each other in a bi-directional manner. In this regard, the central processing computer can transmit signals, data, information, or messages to the law enforcement computer and can receive signals, data, information, or messages transmitted from the law enforcement computer.

The apparatus of the present invention can also include a user communication device which can be associated with, or which can be utilized by, any individual, user, member, subscriber, or entity (hereinafter referred to as “user”), who or which utilizes the apparatus and method of the present invention.

The user communication device can be any computer or computer system, or can be any personal computer, laptop computer, notebook computer, tablet computer, cellular telephone, personal digital assistant, wireless telephone, wireless communication device, personal communication device, personal communications services device, smart phone, mobile telephone, hand-held device or computer, palm-top device or computer, watch, telephone, television, interactive television, digital television, smart television or entertainment device, or any other suitable device.

The user communication device can include any needed or desired computers, processing devices, central processing devices, input devices, output devices, databases or memory devices and/or systems, random access memory (RAM) devices, read only memory (ROM) devices, receivers, transmitters, network interface devices, information or content gathering devices, and/or any other devices, equipments, or systems. Any number, types, or kinds, of user communication devices can be utilized in connection with the apparatus of the present invention. The central processing computer can be connected with and/or linked with the user communication device. The user communication device can also be linked with the central processing computer via a wireless communication network.

The central processing computer and the user communication device can communicate with each other in a bi-directional manner. In this regard, the central processing computer can transmit signals, data, information, or messages to the user communication device and can receive signals, data, information, or messages transmitted from the user communication device.

The apparatus of the present invention can also include a third party computer or communication device (hereinafter “third party communication device”) which can be associated with or utilized by any third party or any third party intermediary, such as, for example, but not limited to, an agent, attorney, or representative, of or associated with any user, a school, a school district, or a school administrator or teacher of or associated with any user, a healthcare provider or doctor of or associated with any user, an employer or a hiring entity of or associated with any user, a parent, legal guardian, friend, or relative, of or associated with any user, or any other third party or third party intermediary, or any person, individual, or entity, that can serve as or function as a third party or a third party intermediary.

The third party communication device can be any computer or computer system, or can be any personal computer, laptop computer, notebook computer, tablet computer, cellular telephone, personal digital assistant, wireless telephone, wireless communication device, personal communication device, personal communications services device, smart phone, mobile telephone, hand-held device or computer, palm-top device or computer, watch, telephone, television, interactive television, digital television, smart television or entertainment device, or any other suitable device, which can be utilized as a third party communication device, which can be utilized by any third party or third party intermediary, or by any individual associated with or employed by same, which can utilize, or which can be involved in the utilization of, the apparatus and method of the present invention, or which can be equipped to perform the functions described herein as being performed by the third party communication device.

The third party communication device can include any needed or desired computers, processing devices, central processing devices, input devices, output devices, databases or memory devices and/or systems, random access memory (RAM) devices, read only memory (ROM) devices, receivers, transmitters, network interface devices, information or content gathering devices, and/or any other devices, equipments, or systems. Any number, types, or kinds, of third party communication devices can be utilized in connection with the apparatus of the present invention. The central processing computer can be connected with and/or linked with the third party communication device. The third party communication device can also be linked with the central processing computer via a wireless communication network.

The central processing computer and the third party communication device can communicate with each other in a bi-directional manner. In this regard, the central processing computer can transmit signals, data, information, or messages to the third party communication device and can receive signals, data, information, or messages transmitted from the third party communication device.

Any the central processing computer can transmit signals, data, information, or messages to, and can receive signals, data, information, or messages transmitted from, the Internet and/or the World Wide Web and any of the legal services provider computers, the law enforcement computers, the user communication devices, and/or the third party communication devices, and/or from any other central processing computers, utilized in connection with the apparatus and method of the present invention.

Each of the central processing computer, the legal services provider computer, the law enforcement computer, the user communication device, and/or the third party communication device, can transmit signals, data, information, or messages to, and can receive signals, data, information, or messages transmitted from, the Internet and/or the World Wide Web and/or the central processing computer, the legal services provider computer, the law enforcement computer, the user communication device, and/or the third party communication device, and/or any other central processing computer, legal services provider computer, law enforcement computer, user communication device, and/or third party communication device, described herein as being utilized in connection with the apparatus of the present invention.

Each of the central processing computer(s), the Internet and/or the World Wide Web, the legal services provider computer(s), the law enforcement computer(s), the user communication device(s), and the third party communication device(s), can transmit information to, as well as receive information from, any of the computers or communication devices as well as the Internet and/or the World Wide Web. In this regard, each of the computers or communication devices, as well as the Internet and/or the World Wide Web, can communicate with, process information from, and/or share data and/or information with, each other and/or any other computer(s) or communication device(s), as well as the Internet and/or the World Wide Web, described herein and/or utilized in conjunction with the present invention. In this manner, data and/or information transfer between any of the computer(s) or communication device(s), as well as the Internet and/or the World Wide Web, can communicate with any other computer(s) or communication device(s), as well as the Internet and/or the World Wide Web, in a bi-directional manner.

The central processing computer(s), the Internet and/or the World Wide Web, the legal services provider computer(s), the law enforcement computer(s), the user communication device(s), and the third party communication device(s), can communicate with one another, and/or be linked to one another, over the Internet and/or the World Wide Web, and/or a communication network, a telecommunication network, a telephone network, a line-connected network, and/or a wireless communication network. Each of the respective computers or communication devices utilized in the present invention, and/or the Internet and/or the World Wide Web, can be linked with any other computer or computers or communication device or communication devices directly or indirectly with one another so as to facilitate a direct or indirect bi-directional communication said respective computers or networks. Communications between each of the respective computers or communication devices utilized in the present invention, and/or the Internet and/or the World Wide Web, can also involve an e-mail server or e-mail servers in those instances when e-mails are described as being used to transmit or send any of the information, signals, messages, reports, notification messages, or any other communications, described herein, by or between any of the respective and herein-described computers or communication devices, and/or the Internet and/or the World Wide Web, or when any of the information, signals, messages, reports, notification messages, or any other communications, described herein, are transmitted by and/or between any of the parties described herein and/or by or between any of the respective computers or communication devices, and/or the Internet and/or the World Wide Web, or any other computers or communication devices, computer systems, communication network equipment, and/or server computers, etc., or any other devices used or needed in order to facilitate communications or the transmission of any of the herein-described information, signals, messages, reports, notification messages, or any other communications.

The apparatus of the present invention can be utilized on, and/or over, the Internet and/or the World Wide Web. The apparatus of the present invention can also utilize wireless Internet and/or World Wide Web services, equipment and/or devices. The central processing computer(s) can have a web site or web sites associated therewith. Each of the legal services provider computers, the law enforcement computers, and/or the third party communication devices can also have a web site or web sites associated with same.

While the Internet and/or the World Wide Web can be a preferred communication system, network, and/or medium, utilized, the present invention can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

The apparatus and method of the present invention can be utilized in order to provide and/or to process information regarding, relating to, or involving, any type or kind of defamatory, derogatory, harassing, bullying, or other negative or offensive, comments, statements, or postings, made, disseminated, or posted, about any user, and/or any user, individual or entity, on the Internet and/or the World Wide Web or on any computers or websites accessible via the Internet and/or the World Wide Web. The apparatus and method of the present invention can be utilized in order to notify or to inform a user, individual or entity, of comments, statements, or postings, which name or refer to the user, individual or entity, and which contain any type or kind of defamatory, derogatory, harassing, bullying, or other negative or offensive, comments, or statements, about or regarding the user, individual or entity, or which can serve to harm or negatively impact upon the user's, individual's, or entity's, reputation, present the user, individual or entity, in a false light, harass or threaten the user, individual or entity, or otherwise ridicule or embarrass the user, individual or entity, or subject the user, individual or entity, to scorn in a public or private forum.

The apparatus of the present invention can be utilized be utilized to notify or inform a user or individual of comments, statements, or postings, which name or refer to a child, a parent, spouse, sibling, a relative, a friend, a client, of the user or individual, or any other person having a relationship with the user or individual and which contain any type or kind of defamatory, derogatory, harassing, bullying, or other negative or offensive, comments, or statements, about or regarding the child, parent, spouse, sibling, relative, friend, or client, of the user or individual or which can serve to harm or negatively impact upon the reputation of the child, parent, spouse, sibling, relative, friend, or client, present the child, parent, spouse, sibling, relative, friend, or client in a false light, harass or threaten the child, parent, spouse, sibling, relative, friend, or client, or otherwise ridicule or embarrass the child, parent, spouse, sibling, relative, friend, or client, or subject the child, parent, spouse, sibling, relative, friend, or client to scorn in a public or private forum.

The apparatus of the present invention can be utilized to notify or inform an attorney, an agent, or a representative, of a user, individual, or entity, of comments, statements, or postings, which name or refer to the user, individual, or the entity, and which contain any type or kind of defamatory, derogatory, harassing, bullying, or other negative or offensive, comments or statements, about or regarding the user, individual, or entity, or which can serve to harm or negatively impact upon the reputation of the user, individual, or entity, present the user, individual, or entity, in a false light, harass or threaten the user, individual, or entity, or otherwise ridicule or embarrass the user, individual, or entity, or subject the user, individual, or entity, to scorn in a public or private forum.

The apparatus and method of the present invention can be utilized to notify or inform an entity of comments, statements, or postings, which name or refer to the entity, or products, services, or activities, of the entity, and which contain any type or kind of defamatory, derogatory, harassing, bullying, or other negative or offensive, comments or statements or which can serve to harm or negatively impact upon the reputation of the entity, present the entity in a false light, harass or threaten the entity, or otherwise ridicule or embarrass the entity, or subject the entity to scorn in a public or private forum.

The apparatus and method of the present invention can be programmed by any user, individual, or entity, or any attorney, agent, or representative, to detect the occurrence or posting of any of the herein-described comments, statements, or postings, which name or refer to the user, individual, or entity, and which contain any type or kind of defamatory, derogatory, harassing, bullying, or other negative or offensive, comments or statements or which can serve to harm or negatively impact upon the reputation of the user, individual, or entity, present the user, individual, or entity, in a false light, harass or threaten the user, individual, or entity, or otherwise ridicule or embarrass the user, individual, or entity, or subject the user, individual, or entity, to scorn in a public or private forum, and notify or inform the user, individual, or entity, or an attorney, agent, or representative, of same.

The apparatus and method of the present invention can be utilized to allow a user, individual, or entity, or an attorney, agent, or representative, of same to respond to any of the herein-described comments, statements, or postings, which name or refer to the user, individual, or entity, and which contain any type or kind of the herein-described defamatory, derogatory, harassing, bullying, or other negative or offensive, comments or statements. The apparatus and method of the present invention can be utilized in order to allow any user, individual, or entity, or an attorney, agent, or representative, of same to respond to, to rebut, or to contact an owner or operator of any computer or website containing or posting, any of the herein-described comments, statements, or postings, which name or refer to the user, individual, or entity, and which contain any type or kind of the herein-described defamatory, derogatory, harassing, bullying, or other negative or offensive, comments, or statements.

The apparatus and method of the present invention can also be utilized in order to record and store any/or information regarding any of the herein-described comments, statements, or postings, which name or refer to the user, individual, or entity, and which contain any type or kind of the herein-described defamatory, derogatory, harassing, bullying, or other negative or offensive, comments or statements, any searches uncovering same, any attempts or activities to have same removed, any attempts or activities to respond to or to rebut same, any referrals to any legal services provider(s), any referrals to any law enforcement agencies, bureaus, or entities, any referrals to any third parties, and/or any activities and/or correspondences sent to and/or received by any of the herein-described users, individuals, members, subscribers, entities, attorneys, agents, representatives, legal services providers, law enforcement agencies, bureaus, or entities, and/or third parties described herein.

The apparatus and method of the present invention can be utilized in order to allow any of the herein-described users, individuals, members, subscribers, entities, or attorneys, agents, or representatives of same, in order to establish an account with the apparatus and/or with the central processing computer and/or to request and/or to program the central processing computer and/or the apparatus to continuously monitor the Internet and/or the World Wide Web in order to detect, and to report on, any occurrences or postings of any and/or all comments, statements, or postings, which name or refer to the user, individual, member, subscriber, or entity, and which contain any type or kind of the herein-described defamatory, derogatory, harassing, bullying, or other negative or offensive, comments or statements.

A user, or his, her, or its, attorney, agent, or representative, can request that search reports be generated by the central processing computer which contain data and/or information regarding each detected occurrence or posting or any and/or all comments, statements, or postings, which name or refer to the user, the website or computer on which herein-described comments, statements, or postings, are or were found, the owner and/or operator of the computer or website, contact information regarding the owner and/or operator of the computer or website, including but not limited to name, address, telephone number, e-mail address or e-mail addresses, officers, directors, or members, including but not limited the names, telephone numbers, and e-mail addresses for each officer, director, or member, and/or any other information or contact information for the company and/or operator. A user, or his, her, or its, attorney, agent, or representative, can also request that any and/or all search reports generated by the central processing computer be transmitted to the user and/or to his, her, or its, attorney, agent, or representative.

A user can access the apparatus of the present invention and establish a user account. Once the account has been established, or if the account already existed, the user, or his, her, or its, attorney, agent, or representative, can also enter into the user communication device and transmit to the central processing computer, any and/or all requests for searches to uncover or detect any occurrences or postings of any and/or all comments, statements, or postings, which name or refer to the user and which contain any type or kind of the herein-described defamatory, derogatory, harassing, bullying, or other negative or offensive, comments or statements.

A user, or his, her, or its, attorney, agent, or representative, can also enter into the user communication device and transmit to the central processing computer, any instructions, parameters, criteria, and/or any other information, for or regarding the formulation of any of the herein-described searches.

A user, or his, her, or its, attorney, agent, or representative, can also enter into the user communication device and transmit to the central processing computer, any search terms or words which should be included in any search requests, a name(s) or a person(s) which or who might be included in a search request(s), a word description of subject matter which can be included in a search request(s), names of individual or entities associated with past comments, statements, or postings, or any defamatory, derogatory, harassing, bullying, or other negative or offensive, comments or statements about the user or about any other individuals, people, groups, or entities, and/or any other information which can be used in the searches performed by the central processing computer or the apparatus of the present invention.

A user, or his, her, or its, attorney, agent, or representative, can also enter into the user communication device and transmit to the central processing computer, any instructions regarding the user desired frequency for having any of the herein-described searches conducted. The user, or his, her, or its, attorney, agent, or representative, can select and/or instruct that searches be performed hourly, daily, every other day, weekly, bi-weekly, monthly, or at any other user-desired or user-selected time interval or frequency. The user, or his, her, or its, attorney, agent, or representative, can also enter into the user communication device and transmit to the central processing computer, any instructions regarding the mode and/or manner for being notified or informed of any of the herein-described detected occurrences or postings of any and/or all comments, statements, or postings, as well as the mode and/or manner for being provided with any messages regarding same, any messages regarding the availability of any search reports or other reports or messages regarding or relating to same, and any search reports, search report messages, or any other messages containing any and/or all information regarding or relating to the results of any of the herein-described searches.

Alerts, alert messages, notification messages, search reports, search report messages, or any other messages or reports, can be utilized to transmit or to convey any of the herein-described information, regarding or relating to any of the herein-described detected occurrences or postings of any and/or all comments, statements, or postings, any messages regarding same, any messages regarding the availability of any search reports, search report messages, or other reports or messages regarding or relating to same, and any search reports or messages containing any and/or all information regarding or relating to the results of any of the herein-described searches. Any of the herein-described alerts, alert messages, notification messages, search reports, search report messages, or any other messages or reports, can be, or can be contained in, an e-mail message, an instant messaging message, an SMS message, an electronic message or transmission of any kind or type, a pre-recorded telephone message, a pre-recorded voicemail message, or any other type, kind, or form, of message or report.

Any of the herein-described alerts, alert messages, notification messages, search reports, search report messages, or any other messages or reports, can contain a link(s) or a hyperlink(s) to any of the computers or websites on which any comments, statements, or postings, are found, contained, or posted, a link(s) or a hyperlink(s) to any owner and/or operator of same, and/or a link(s) or a hyperlink(s) to any of the herein-described legal services provider computer(s) law enforcement computer(s), the third party communication device(s), or any other user communication device(s), as well as to an computer or communication device utilized by or associated with the user, or his, her, or its, attorney, agent, or representative.

The central processing computer can receive, process, and store the information and/or instructions transmitted from the user communication device. If an account needs to be established, the central processing computer can establish the account. The central processing computer can also process any and/or all information and/or instructions regarding the account so that the central processing computer can be programmed to perform any and/or all requested or instructed searches, operations, and/or functions.

If a user already has an account, the step of establishing an account can be dispensed with and the user, or his, her, or its, attorney, agent, or representative, can access the central processing computer and can enter any new or additional requests or instructions or make changes or revisions to any previous request or instructions.

The apparatus of the present invention can perform searches for a user, and upon detecting any occurrence or posting or any and/or all comments, statements, or postings, which name or refer to the user and which contain any type or kind of the herein-described defamatory, derogatory, harassing, bullying, or other negative or offensive, comments or statements, can generate any one or more of any of the herein-described alerts, alert messages, or notification messages, and transmit same to the user communication device associated with or utilized by the user. The apparatus and/or the central processing computer can also generate any of the herein-described search reports, search report messages, or any other messages or reports and can also transmit same to the user communication device automatically and/or in response to the user requesting same via the user communication device.

The apparatus and/or the central processing computer can be programmed to, or can respond to a user instruction to, transmit a correspondence or a letter, the content and/or subject matter of which can be provided by the user or by the user's attorney, agent, or representative, or which can be selected by the user from among a number of prepared correspondence forms or letter forms provided by, and/or stored in apparatus or the central processing computer, to any of the owners or operators of any computers or websites on which the offending comments, statements, or postings, appear or are posted and which can inform the respective owner or operator of the computer or website of the existence of the offending comment, statement, or posting, and/or which can also include a request or a demand that the offending comment, statement, or posting, be removed from the computer or website.

The apparatus and./or the central processing computer can also be programmed to, or can respond to a user instruction to, transmit rebuttal messages or response messages, for posting on the computers or websites on which the offending comments, statements, or postings, appear or are posted. The apparatus and./or the central processing computer can also programmed to, or can respond to a user instruction to, transmit rebuttal messages or response messages to the computers or websites on which the offending comments, statements, or postings, appear or are posted, or to the owners and operators of same. Any of the rebuttal messages or response messages described herein can be provided or dictated by the user or can be selected from among prepared rebuttal messages or response messages provided by, and/or stored in the central processing computer.

Any of the herein-described searches for a user, detected occurrences or postings of any and/or all comments, statements, or postings, detected for found, and/or any of the herein-described alerts, alert messages, or notification messages, search reports, search report messages, or any other messages or reports, and/or any of the herein-described correspondences or letters, rebuttal messages and/or response messages, can be stored in the database of the central processing computer for later retrieval and/or use in any appropriate manner. The apparatus can be utilized to search for comments, statements, or postings, which can either name the user, or name an individual or entity, such as, but not limited to a parent, spouse, child, sibling, or any other relative, or a client or customer, or any other individual or entity for whom the user may have an interest in protecting from any type or kind of the herein-described defamatory, derogatory, harassing, bullying, or other negative or offensive, comments or statements, or any other unwanted comments, statements, or postings.

The apparatus, once previously programmed for performing searches for a user, can be programmed to await an occurrence of a searching event. The searching event can occur at a pre-determined time interval or time intervals previously selected by the user. In a preferred embodiment, the searching event can be programmed to occur every hour. In another preferred embodiment, the searching event can be programmed to occur daily, every other day, weekly, bi-weekly, or monthly, or at any other frequency.

Upon the occurrence of a scheduled searching event, the apparatus can perform all of the requested searches on or of the Internet and/or the World Wide Web using any and/or all available Internet search engines. The searches can be performed on any and/or all public networks or websites, private networks or websites, and/or social networking websites, and can be performed on public information as well as information contained on or in private networks. Each search can be formulated to search for any comments, statements, or postings, which name or refer to the user, or any individual or entity for whom the user desires the search to be performed, and which contain any type or kind of defamatory, derogatory, harassing, bullying, or other negative or offensive, comments or statements.

The apparatus of the present invention or the central processing computer can, for each search request, perform a search of the Internet and/or the World Wide Web using each available Internet search engine, and can generate, for each Internet search engine utilized, a search engine search request report containing the results obtained for all searches performed pursuant to a search request using the Internet search engine.

The apparatus of the present invention or the central processing computer can perform all searches pursuant to all search requests using any and/or all available Internet search engines, and can generate all corresponding search engine search request reports for all search requests and for all searches pursuant to same performed using all of the available Internet search engines. The apparatus of the present invention or the central processing computer can also generate a search report containing all of the search results obtained for all searches performed using any and/or all available Internet search engines for all of the search requests. The search report will contain all detected or discovered comments, statements, or postings, which name or refer to the user, or any individual or entity for whom the user desires the search to be performed, and which contain any type or kind of defamatory, derogatory, harassing, bullying, or other negative or offensive, comments or statements.

Any search report generated can contain, for each detected comment, statement, or posting, a link(s) or hyperlink(s) to any computer(s) or website(s), and/or to any owner or operator of same, associated with each detected comment, statement, or posting, a link(s) or hyperlink(s), a link(s) or a hyperlink(s) to an officer, attorney, or other individual or entity, associated with the computer(s), the website(s)), and/or to any owner or operator of same, a link(s) or a hyperlink(s) to the central processing computer and to a link(s) or hyperlink(s) for instructing the central processing computer to either transmit to the owner or operator of the computer or website containing the respective comment, statement, or posting, a message identifying the comment, statement, or posting, and demanding same to be removed or deleted, or transmit to the owner or operator of the computer or website containing the respective comment, statement, or posting, a message identifying the comment, statement, or posting, and containing a response message to same or a rebuttal message to same and requesting or demanding that the response message or the rebuttal message be posted to respond to the comment, statement, or posting. Any response message or rebuttal message can be prepared beforehand and can be stored and/or retrieved in or from the central processing computer or same can be prepared by the user using the user communication device, at that time or in real-time, and can be transmitted to the central processing computer along with the respective instruction.

Any search report can also contain, for each detected comment, statement, or posting, a link(s) or hyperlink(s) to one or more of any of the herein-described legal services provider computers, law enforcement computers, other user communication devices, or third party communication devices, and/or other central processing computers. In this regard, a user can report and/or forward the respective comment, statement, or posting, to a respective attorney, law enforcement agency, another user, or a third party.

The apparatus or the central processing computer can also store each and every search report in the central processing computer. The apparatus or the central processing computer can also create a file for each computer or website, or owner or operator of same, in which any comments, statements, or postings, which name or refer to the user and which contain any type or kind of the herein-described defamatory, derogatory, harassing, bullying, or other negative or offensive, comments or statements, are found to exist.

The apparatus of the present invention or the central processing computer can also generate an alert, an alert message, or a notification message, containing information for notifying or informing the user of or regarding any detected occurrence or occurrences of any of the herein-described detected comments, statements, or postings, and/or the generation and availability of the search report. The alert, alert message, or notification message, can contain or have attached thereto the search report and/or can also have a link(s) or hyperlink(s) to the search report and/or to any other previously generated search report(s).

The apparatus or the central processing computer can also transmit the alert, alert message, or notification message, along with the attached search report, to the user communication device. The apparatus or the central processing computer 10 can also, pursuant to previously provided instructions, also transmit the alert, alert message, or notification message, along with the attached search report, to an legal services provider computer associated with or used by an attorney, agent, or representative, of the user, to a law enforcement computer associated with or used by a law enforcement agency previously selected by the user, to another user computer associated with or used by another user previously selected by the user to receive same, and/or to a third party communication device associated with or used by a previously selected third party.

The user communication device can receive the alert, alert message, or notification message and the user can access and review the alert, alert message, or notification message, and can access and review the search report. The user can also utilize any of the information, link(s), or hyperlinks, contained in the search report in order to review the results contained therein, including any and/or all of the herein-described comments, statements, or postings, which name the user, or other individual or entity. The user can also utilize any information, link(s), or hyperlink(s) contained in the search report in order to perform any task or function, or to instruct the apparatus or the central processing computer to perform any task or function for or on behalf of the user. For example, the user can review any and/or all of the herein-described comments, statements, or postings in the search report, and/or the user can contact the owner or operator of a computer or website posting a comment, statement, or posting, and/or transmit a message, a response message, a rebuttal message, a cease and desist message, or a message demanding that the owner or operator of a computer or website, posting a comment, statement, or posting, remove or delete same from it's computer or website.

The user can also contact an attorney, agent, or representative, of the owner or operator of a computer or website posting a comment, statement, or posting, and/or transmit a message, a response message, a rebuttal message, a cease and desist message, or a message demanding that the owner or operator of a computer or website, posting a comment, statement, or posting, remove or delete same from it's computer or website.

The user can also instruct the apparatus or the central processing computer to contact the owner or operator of a computer or website posting a comment, statement, or posting, and/or transmit a message, a response message, a rebuttal message, a cease and desist message, or a message demanding that the owner or operator of a computer or website, posting a comment, statement, or posting, remove or delete same from it's computer or website. The user can also instruct the apparatus or the central processing computer to contact an attorney, agent, or representative, of the owner or operator of a computer or website posting a comment, statement, or posting, and/or transmit a message, a response message, a rebuttal message, a cease and desist message, or a message demanding that the owner or operator of a computer or website, posting a comment, statement, or posting, remove or delete same from it's computer or website.

The user can also select from among stored response messages, rebuttal messages, cease and desist messages, or messages demanding that a comment, statement, or posting, be removed or deleted from a computer or website, a message or messages which the user wants to transmit, or have the apparatus or the central processing computer transmit, to an owner or operator of a computer or website or to a computer or communication device associated with the owner or operator. The user can also prepare and transmit a response message, a rebuttal message, a cease and desist message, or a message demanding that a comment, statement, or posting, be removed or deleted from a computer or website, to the apparatus or to the central processing computer, or to an owner or operator of a computer or website or to a computer or communication device associated with the owner or operator. The user can also instruct the central processing computer to transmit the response message, rebuttal message, cease and desist message, or message demanding that a comment, statement, or posting, be removed or deleted from a computer or website, to an owner or operator of a computer or website or to a computer or communication device associate therewith.

The user can also access any computer or website which contains a detected comment, statement, or posting, described herein and post a response message, a rebuttal message in response to, in reply to, or to counter, any detected comment, statement, or posting. The user can also access a computer or website containing a detected comment, statement, or posting, and post a response message, a rebuttal message, a cease and desist message, a cease and desist message directed to the individual responsible for posting a comment, statement, or posting, or any other comment countering or providing the user's position or response to or regarding a comment, statement, or posting. In a situation where an owner or operator of a computer or website can provide the user with the ability to remove, delete, or expunge, a detected comment, statement, or posting, the user can access the computer or website using the user communication device either directly, or via a link or hyperlink in the search report, and remove, delete, or expunge, the detected comment, statement, or posting.

The user can also forward the alert, alert message, or notification message, and/or the search report, and any and/or off or the comments, statements, or postings, contained therein, to any one or more of any of the herein-described legal services provider computers, law enforcement computers, other user communication devices, or third party communication devices, and/or other central processing computers, so as to report same to any of the users, individuals, or entities associated with any of the herein-described computers or communication devices. In this regard, a user can report a comment(s), statement(s), or posting(s) to his or her attorney, agent, or representative, a law enforcement agency, a third party, or another user. The user can also transmit any instructions and/or any messages prepared by the user to the apparatus or to the central processing computer.

The apparatus or the central processing computer can receive and process any instructions and/or messages and can perform the tasks requested by or instructed by the user. The apparatus or the central processing computer can also receive, store, and forward or transmit to the user communication device, any responses received from, or notes regarding any actions taken by, any owner or operator of any computer or website in response to any response message, rebuttal message, cease and desist message, or message demanding that a comment, statement, or posting, be removed or deleted from a computer or website which was transmitted to the owner or operator. The apparatus or the central processing computer can also transmit to any one or more of any of the herein-described legal services provider computers, law enforcement computers, any other user communication devices, or third party communication devices, and/or other central processing computers, any responses received from, or notes regarding any actions taken by, any owner or operator of any computer or website in response to any response message, rebuttal message, cease and desist message, or message demanding that a comment, statement, or posting, be removed or deleted from a computer or website which was transmitted to the owner or operator.

The apparatus or the central processing computer can store any of the herein-described and generated alerts, alert messages, notification messages, and search reports, any information or instructions received from the user, as well as any information regarding any of the actions taken by the apparatus or the central processing computer for or on behalf of the user and any responses received from, or notes regarding any actions taken by, any owner or operator of any computer or website in response to any response message, rebuttal message, cease and desist message, or message demanding that a comment, statement, or posting, be removed or deleted from a computer or website which was transmitted to the owner or operator.

The apparatus or the central processing computer can store in a file associated with any owner or operator of any computer or website, any of the herein-described information relating to that particular owner or operator.

The apparatus or the central processing computer can also be programmed or pre-programmed to perform any of the tasks described herein which the user can or may instruct the central processing computer to do on the user's behalf or pursuant to the user's instructions. For example, the central processing computer can be programmed so that upon receiving and processing any search results for any search requests, or upon generating the search report, the alert, the alert message, or the notification message, the central processing computer can, for any and/or all detected comments, statements or postings, to perform any task or function for or on behalf of the user, contact the owner or operator of a computer or website posting a comment, statement, or posting, and/or transmit a message, a response message, a rebuttal message, a cease and desist message, or a message demanding that the owner or operator of a computer or website remove or delete same from it's computer or website.

Any alerts, alert messages, notification messages, search reports, or any other messages or reports, can be, or can be contained in, an e-mail message, an instant messaging message, an SMS message, an electronic message or transmission of any kind or type, a pre-recorded telephone message, a pre-recorded voicemail message, or any other type, kind, or form, of message or report.

The apparatus or the central processing computer can also be programmed or pre-programmed to transmit the alert, the alert message, or the notification message, and/or any search report and/or any detected comment(s), statement(s), or posting(s), to a legal services provider computer(s) associated with or used by an attorney, agent, or representative, of the user, a law enforcement computer associated with a law enforcement agency or bureau, any other user communication device associated with or used by the user or any other user, or any third party communication device. The apparatus or the central processing computer can also be programmed or pre-programmed to contact an attorney, agent, or representative, of the user and/or of the owner or operator of a computer or website posting a comment, statement, or posting, and/or transmit a message, a response message, a rebuttal message, a cease and desist message, or a message demanding that the owner or operator of a computer or website, posting a comment, statement, or posting, remove or delete same from it's computer or website.

The apparatus or the central processing computer can also be programmed or pre-programmed to contact the owner or operator of a computer or website posting a comment, statement, or posting, and to transmit a message, a response message, a rebuttal message, a cease and desist message, or a message demanding that the owner or operator of a computer or website remove or delete same from it's computer or website.

The apparatus or the central processing computer can also be programmed or pre-programmed to automatically access as computer or website containing a detected comment, statement, or posting, and post a response message, a rebuttal message in response to, in reply to, or to counter, any detected comment, statement, or posting for or on behalf of the user.

The apparatus or the central processing computer can also be programmed or pre-programmed to generate and/or to transmit a response message, rebuttal message, cease and desist message, or message demanding that a comment, statement, or posting, be removed or deleted from a computer or website, to an owner or operator of a computer or website or to a computer or communication device associated therewith.

The apparatus or the central processing computer can also be programmed or pre-programmed to forward the alert, alert message, or notification message, and/or the search report, and any and/or off or the comments, statements, or postings, contained therein, to any one or more of any of the herein-described legal services provider computers, law enforcement computers, other user communication devices, or third party communication devices, and/or other central processing computers, so as to automatically report same to any of the users, individuals, or entities associated with any of the herein-described computers or communication devices.

The apparatus or the central processing computer can also be programmed or pre-programmed to access a computer or website containing a comment, statement, or posting, and post a response message, a rebuttal message, a cease and desist message, a cease and desist message directed to the individual responsible for posting a comment, statement, or posting, or any other comment countering or providing the user's position or response to or regarding a comment, statement, or posting. In a situation where an owner or operator of a computer or website can provide the apparatus or the central processing computer with the ability to remove, delete, or expunge, a detected comment, statement, or posting, the apparatus or the central processing computer can be programmed or pre-programmed to automatically access the computer or website and automatically remove, delete, or expunge, the detected comment, statement, or posting.

The apparatus of the present invention can also be utilized by a parent user to monitor any comments, statements, or postings, naming his or her child, and/or so as to be alerted to and/or so as to report instances of cyber-bullying or any other bullying activities. The apparatus of the present invention can also be utilized by any user to monitor any comments, statements, or postings, naming him or her, his or her spouse, relatives, friends, clients, suppliers, customers, or his or her business, so as to be alerted to and/or so as to report instances of defamation, libel, slander, harassment, criminal activity, product or trade disparagement, and/or any other bad acts by others.

The apparatus, the central processing computer, and/or the user communication device, can also be programmed to automatically respond to, remove, delete, or expunge, any of the herein-described detected comments, statements, or postings and to record and store any information regarding the respective comments, statements, or postings, and the responses to, removal, deletion, or expunging, of same.

Any search reports can contain information regarding, or a link to or a hyperlink to, any computer or website on which a detected comment, statement, or posting, has been found or is posted. In this manner the user can communicate directly with the computer or website via his or her user communication device or otherwise.

Any and/or all of the data and/or information regarding, and dates and times of, any and/or all of the searches performed, searching events, and scheduled searching events, generation and/or transmission of any of the herein-described alerts, alert messages, notification messages, search reports, any task or function which an be performed with the apparatus of the present invention, any transmission of or forwarding of any information described-herein and/or any search reports to any legal services provider computer, law enforcement computer, any other user communication devices, and/or third party computers, and/or any of the herein-described instructions, and/or any of the herein-described actions performed by the user(s) and/or by the apparatus or the central processing computer for or on behalf of the user or pursuant to instructions, can be stored by or in the apparatus or the central processing computer.

Any and/or all of the search engine search request reports, search reports, alerts, alert messages, notification messages, search results, comments, statements, or postings, response messages, rebuttal messages, cease and desist messages, response messages, rebuttal messages, and/or cease and desist messages, and/or any other messages, and/or any responses by any of the owners or operators of any computers or websites, can be date-stamped and/or time-stamped and stored in the apparatus or in the central processing computer and/or in the user communication device.

The apparatus of the present invention and/or the central processing computer can receive, store, and/or transmit, to the user communication device, and/or to the legal services provider computers, to the law enforcement computers, to any other user communication devices, or to the third party communication devices, and/or to any other central processing computers, any of the herein-described response messages, rebuttal messages, and/or cease and desist messages, and/or any other messages, transmitted to the owners or operators of the computers or websites and/or any responses or replies or correspondence received from any owners or operators of the computers or websites.

In any an/or all of the embodiments described herein, any signals, data, information, messages, reports, or any other transmissions can be date-stamped and/or time-stamped.

The apparatus and method of the present invention can also be utilized in order to inform or to notify any of the herein-described users, individuals, members, subscribers, or entities of comments, statements, or postings, which name of refer to them and which contain any type or kind of the herein-described defamatory, derogatory, harassing, bullying, or other negative or offensive, comments or statements. The apparatus and method of the present invention can also be utilized in order to inform or to notify any of the herein-described users, individuals, members, subscribers, or entities of comments, statements, or postings which names of refers to any individual, a child, a spouse, a relative, a friend, a business colleague, and/or any other individual or entity, for whom they are responsible for caring or for whom they choose to look after or care for, or for whom they choose to utilize the apparatus of the present invention.

Any and/or all of the herein-described search requests, search engine search request reports, search reports, alerts, alert messages, notification messages, search results, comments, statements, or postings, user instructions, response messages, rebuttal messages, cease and desist messages, response messages, rebuttal messages, and/or cease and desist messages, and/or any other messages, and/or any responses by any of the owners or operators of any computers or websites, can be date-stamped and/or time-stamped and/or can be stored in the central processing computer and/or in the user communication device, and/or in any of the legal services provider computers, the law enforcement computers, any other user communication devices, or the third party communication devices, and can be utilized as evidence in any legal proceedings or legal actions or law suits involving any user and any owner or operator of any website or any individual or person who posts any of the herein-described comments, statements, or postings, which name of refer to the user, or any other individual or entity, and which contain any type or kind of the herein-described defamatory, derogatory, harassing, bullying, or other negative or offensive, comments or statements.

A user can also access the apparatus or the central processing computer at any time in order to request new, additional, or modified search requests. A user can also access the apparatus or the central processing computer at any time to access stored search requests, search engine search request reports, search reports, alerts, alert messages, notification messages, search results, comments, statements, or postings, user instructions, response messages, rebuttal messages, cease and desist messages, response messages, rebuttal messages, and/or cease and desist messages, and/or any other messages, and/or any responses by any of the owners or operators of any computers or websites.

The apparatus of the present invention can also store activity reports for any of the herein-described accounts. The activity reports can contain records, including date and/or time of same, for any and/or all activities or processing activities on or involving an account. The activity reports can also contain records regarding and of the herein-described search requests, search engine search request reports, search reports, alerts, alert messages, notification messages, search results, comments, statements, or postings, user instructions, response messages, rebuttal messages, cease and desist messages, response messages, rebuttal messages, and/or cease and desist messages, and/or any other messages, and/or any responses by any of the owners or operators of any computers or websites, including data and/or time of same, and any user(s), individual(s), member(s), subscriber(s), entity or entities, computer(s) or website(s), legal service provider(s), law enforcement agency or agencies, or third party or third parties, involved in same.

### BRIEF DESCRIPTION OF THE DRAWINGS

In the Drawings:

FIG. 1 illustrates a preferred embodiment of the apparatus of the present invention, in block diagram form;

FIG. 2 illustrates a preferred embodiment of the central processing computer of FIG. 1, in block diagram form;

FIG. 3 illustrates a preferred embodiment of the user communication device of FIG. 1, in block diagram form;

FIG. 4 illustrates a preferred embodiment method for utilizing the present invention, in flow diagram form; and

FIGS. 5A and 5B illustrates a preferred embodiment method for utilizing the present invention, in flow diagram form.

### DESCRIPTION OF THE PREFERRED EMBODIMENT

The present invention pertains to an apparatus and method for providing and/or for processing information regarding, relating to, or involving, defamatory, derogatory, harassing, bullying, or other negative or offensive, comments, statements, or postings. The present invention can be utilized in a number of preferred embodiments in order to notify users, individuals, members, subscribers, or entities, when comments, statements, or postings, which name them and which contain defamatory, derogatory, harassing, bullying, or other negative or offensive, comments, statements, or postings, regarding them are detected on the Internet and/or the World Wide Web, and provides the respective users, individuals, members, subscribers, or entities, with the ability to respond to same, to counter same, to have same removed, deleted, or expunged, and/or to take measures to protect their reputations or the reputations of others.

Applicant hereby incorporates by reference herein the subject matter and teachings of U.S. Provisional Patent Application Ser. No. 61/851,093, filed Mar. 1, 2013, and entitled “APPARATUS AND METHOD FOR PROVIDING AND/OR FOR PROCESSING INFORMATION REGARDING, RELATING TO, OR INVOLVING, DEFAMATORY, DEROGATORY, HARRASSING, BULLYING, OR OTHER NEGATIVE OR OFFENSIVE, COMMENTS, STATEMENTS, OR POSTINGS”, the subject matter and teachings of which are hereby incorporated by reference herein in their entirety.

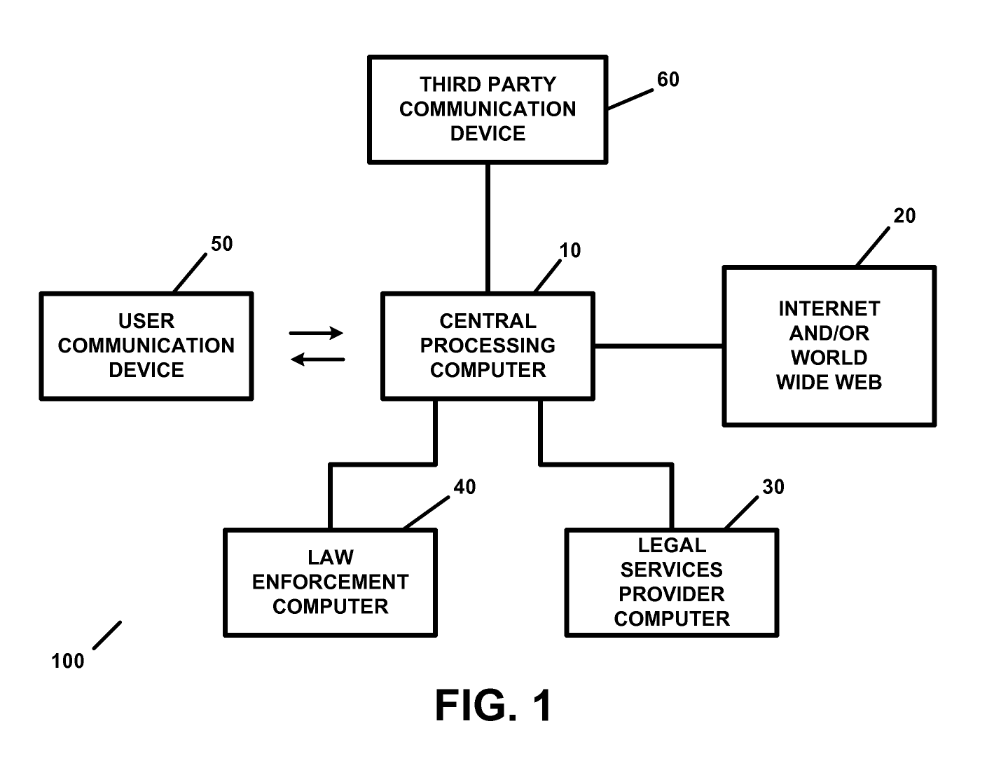

FIG. 1 illustrates a preferred embodiment of the apparatus of the present invention, which is denoted by the reference numeral 100, in block diagram form. With reference to FIG. 1, the apparatus 100 includes a central processing computer 10 which can perform any of the processing routines and functionality described herein as being performed by the apparatus 100 of the present invention. In a preferred embodiment, the central processing computer 10 can be any computer, computer system, group of computers, server, server system, or group of servers which can be programmed and equipped to perform any of the herein-described functions, operations, or actions described herein as being performed by the central processing computer 10 and the apparatus 100 of the present invention. In a preferred embodiment, the central processing computer 10 can include any needed or desired computers, processing devices, central processing devices, input devices, output devices, databases or memory devices and/or systems, random access memory (RAM) devices, read only memory (ROM) devices, receivers, transmitters, network interface devices, information or content gathering devices, and/or any other devices, equipments, or systems. Any number of central processing computers 10 can be utilized in conjunction with the apparatus 100 of the present invention.

In another preferred embodiment, any of the central processing computers 10 described as being utilized in connection or in conjunction with the apparatus 100 and method or the present invention can also be performed by or implemented using cloud computer hardware and/or software. In this regard, any and/or all of the central processing computers 10 described herein can be implemented using a cloud computing architecture, server computers or network computers, and/or any cloud computing hardware and/or software.

With reference once again to FIG. 1, the apparatus 100 operates in connection with the Internet and/or the World Wide Web 20 and/or any and/or all of the numerous computers, computer systems, server computers, websites, web hosting computers, web hosting services computers, and/or any other computers, devices, or entities, which are included in, or which operate on, via, or in connection with, the Internet and/or the World Wide Web. In this regard, in a preferred embodiment, the apparatus 100 and/or the central processing computer 10 also operates on, via, or in connection with, the Internet and/or the World Wide Web, so as to operate on, via, or in connection with, the Internet and/or the World Wide Web 20 of FIG. 1. In a preferred embodiment, the central processing computer 10 is connected to and/or linked with the Internet and/or the World Wide Web 20. In a preferred embodiment, the central processing computer 10 can also be linked with the Internet and/or the World Wide Web 20 via a wireless communication network.

With reference once again to FIG. 1, the apparatus 100 also includes a legal services provider computer or communication device 30 (hereinafter “legal services provider computer 30”) which can be associated with or utilized by any law firm, lawyer, attorney, paralegal, law firm employee, or any other provider of legal services or employee or other person associated with same, who or which can utilize, or which can be involved in the utilization of, the apparatus 100 of the present invention in order to provide legal services for any individuals, users, members, or subscribers, who or which utilize the apparatus 100 and method of the present invention. In a preferred embodiment, the legal services provider computer 30 can be any computer or computer system, or can be any personal computer, laptop computer, notebook computer, tablet computer, cellular telephone, personal digital assistant, wireless telephone, wireless communication device, personal communication device, personal communications services device, smart phone, mobile telephone, hand-held device or computer, palm-top device or computer, watch, telephone, television, interactive television, digital television, smart television or entertainment device, or any other suitable device, which can be utilized as a legal services provider computer 30, which can be utilized by any law firm, lawyer, attorney, paralegal, law firm employee, or any other provider of legal services or employee or other person associated with same who or which can utilize, or which can be involved in the utilization of, the apparatus 100 of the present invention, or which can be equipped to perform the functions described herein as being performed by the legal services provider computer 30.

In a preferred embodiment, the legal services provider computer 30 can include any needed or desired computers, processing devices, central processing devices, input devices, output devices, databases or memory devices and/or systems, random access memory (RAM) devices, read only memory (ROM) devices, receivers, transmitters, network interface devices, information or content gathering devices, and/or any other devices, equipments, or systems. In a preferred embodiment, any number, types, or kinds, of legal services provider computers 30 can be utilized in connection with the apparatus 100 of the present invention. In a preferred embodiment, the central processing computer 10 can be connected with and/or linked with the legal services provider computer 30. In a preferred embodiment, the legal services provider computer 30 can also be linked with the central processing computer 10 via a wireless communication network.

In a preferred embodiment, the central processing computer 10 and the legal services provider computer 30 can communicate with each other in a bi-directional manner. In this regard, the central processing computer 10 can transmit signals, data, information, or messages to the legal services provider computer 30 and can receive signals, data, information, or messages transmitted from the legal services provider computer 30.

With reference once again to FIG. 1, the apparatus 100 also includes a law enforcement computer or communication device 40 (hereinafter “law enforcement computer 40”) which can be associated with or utilized by any public or private law enforcement agency, bureau, department, company or entity, or which can be associated with or utilized by any individual associated with or employed by same, who or which can utilize the apparatus 100 and method of the present invention.

In a preferred embodiment, the law enforcement computer 40 can be any computer or computer system, or can be any personal computer, laptop computer, notebook computer, tablet computer, cellular telephone, personal digital assistant, wireless telephone, wireless communication device, personal communication device, personal communications services device, smart phone, mobile telephone, hand-held device or computer, palm-top device or computer, watch, telephone, television, interactive television, digital television, smart television or entertainment device, or any other suitable device, which can be utilized as a law enforcement computer 40, which can be utilized by any public or private law enforcement agency, bureau, department, company or entity, or by any individual associated with or employed by same, which can utilize, or which can be involved in the utilization of, the apparatus 100 and method of the present invention, or which can be equipped to perform the functions described herein as being performed by the law enforcement computer 40.

In a preferred embodiment, the law enforcement computer 40 can include any needed or desired computers, processing devices, central processing devices, input devices, output devices, databases or memory devices and/or systems, random access memory (RAM) devices, read only memory (ROM) devices, receivers, transmitters, network interface devices, information or content gathering devices, and/or any other devices, equipments, or systems. In a preferred embodiment, any number, types, or kinds, of law enforcement computers 40 can be utilized in connection with the apparatus 100 of the present invention. In a preferred embodiment, the central processing computer 10 can be connected with and/or linked with the law enforcement computer 40. In a preferred embodiment, the law enforcement computer 40 can also be linked with the central processing computer 10 via a wireless communication network.

In a preferred embodiment, the central processing computer 10 and the law enforcement computer 40 can communicate with each other in a bi-directional manner. In this regard, the central processing computer 10 can transmit signals, data, information, or messages to the law enforcement computer 40 and can receive signals, data, information, or messages transmitted from the law enforcement computer 40.

With reference once again to FIG. 1, the apparatus 100 also includes a user communication device 50 which can be associated with, or which can be utilized by, any individual, user, member, subscriber, or entity (hereinafter referred to as “user”), who or which utilizes the apparatus 100 and method of the present invention.

In a preferred embodiment, the user communication device 50 can be any computer or computer system, or can be any personal computer, laptop computer, notebook computer, tablet computer, cellular telephone, personal digital assistant, wireless telephone, wireless communication device, personal communication device, personal communications services device, smart phone, mobile telephone, hand-held device or computer, palm-top device or computer, watch, telephone, television, interactive television, digital television, smart television or entertainment device, or any other suitable device.

In a preferred embodiment, the user communication device 50 can include any needed or desired computers, processing devices, central processing devices, input devices, output devices, databases or memory devices and/or systems, random access memory (RAM) devices, read only memory (ROM) devices, receivers, transmitters, network interface devices, information or content gathering devices, and/or any other devices, equipments, or systems. In a preferred embodiment, any number, types, or kinds, of user communication devices 50 can be utilized in connection with the apparatus 100 of the present invention. In a preferred embodiment, the central processing computer 10 can be connected with and/or linked with the user communication device 50. In a preferred embodiment, the user communication device 50 can also be linked with the central processing computer 10 via a wireless communication network.

In a preferred embodiment, the central processing computer 10 and the user communication device 50 can communicate with each other in a bi-directional manner. In this regard, the central processing computer 10 can transmit signals, data, information, or messages to the user communication device 50 and can receive signals, data, information, or messages transmitted from the user communication device 50.

With reference once again to FIG. 1, the apparatus 100 also includes a third party computer or communication device 60 (hereinafter “third party communication device 60”) which can be associated with or utilized by any third party or any third party intermediary, such as, for example, but not limited to, an agent, attorney, or representative, of or associated with any user, a school, a school district, or a school administrator or teacher of or associated with any user, a healthcare provider or doctor of or associated with any user, an employer or a hiring entity of or associated with any user, a parent, legal guardian, friend, or relative, of or associated with any user, or any other third party or third party intermediary, or any person, individual, or entity, that can serve as or function as a third party or a third party intermediary.

In a preferred embodiment, the third party communication device 60 can be any computer or computer system, or can be any personal computer, laptop computer, notebook computer, tablet computer, cellular telephone, personal digital assistant, wireless telephone, wireless communication device, personal communication device, personal communications services device, smart phone, mobile telephone, hand-held device or computer, palm-top device or computer, watch, telephone, television, interactive television, digital television, smart television or entertainment device, or any other suitable device, which can be utilized as a third party communication device 60, which can be utilized by any third party or third party intermediary, or by any individual associated with or employed by same, which can utilize, or which can be involved in the utilization of, the apparatus 100 and method of the present invention, or which can be equipped to perform the functions described herein as being performed by the third party communication device 60.

In a preferred embodiment, the third party communication device 60 can include any needed or desired computers, processing devices, central processing devices, input devices, output devices, databases or memory devices and/or systems, random access memory (RAM) devices, read only memory (ROM) devices, receivers, transmitters, network interface devices, information or content gathering devices, and/or any other devices, equipments, or systems. In a preferred embodiment, any number, types, or kinds, of third party communication devices 60 can be utilized in connection with the apparatus 100 of the present invention. In a preferred embodiment, the central processing computer 10 can be connected with and/or linked with the third party communication device 60. In a preferred embodiment, the third party communication device 60 can also be linked with the central processing computer 10 via a wireless communication network.

In a preferred embodiment, the central processing computer 10 and the third party communication device 60 can communicate with each other in a bi-directional manner. In this regard, the central processing computer 10 can transmit signals, data, information, or messages to the third party communication device 60 and can receive signals, data, information, or messages transmitted from the third party communication device 60.

In a preferred embodiment, any the central processing computer 10 can transmit signals, data, information, or messages to, and can receive signals, data, information, or messages transmitted from, the Internet and/or the World Wide Web 20 and any of the legal services provider computers 30, the law enforcement computers 40, the user communication devices 50, and/or the third party communication devices 60, and/or from any other central processing computers 10, utilized in connection with the apparatus 100 and method of the present invention.

In a preferred embodiment, each of the central processing computer 10, the legal services provider computer 30, the law enforcement computer 40, the user communication device 50, and/or the third party communication device 60, can transmit signals, data, information, or messages to, and can receive signals, data, information, or messages transmitted from, the Internet and/or the World Wide Web 20 and/or the central processing computer 10, the legal services provider computer 30, the law enforcement computer 40, the user communication device 50, and/or the third party communication device 60, and/or any other central processing computer 10, legal services provider computer 30, law enforcement computer 40, user communication device 50, and/or third party communication device 60, described herein as being utilized in connection with the apparatus 100 of the present invention.

Each of the central processing computer(s) 10, the Internet and/or the World Wide Web 20, the legal services provider computer(s) 30, the law enforcement computer(s) 40, the user communication device(s) 50, and the third party communication device(s) 60, can transmit information to, as well as receive information from, any of the computers or communication devices 10, 30, 40, 50, and 60, as well as the Internet and/or the World Wide Web 20. In this regard, each of the computers or communication devices 10, 30, 40, 50, and 60, as well as the Internet and/or the World Wide Web 20, can communicate with, process information from, and/or share data and/or information with, each other and/or any other computer(s) or communication device(s) 10, 30, 40, 50, and 60, as well as the Internet and/or the World Wide Web 20, described herein and/or utilized in conjunction with the present invention. In this manner, data and/or information transfer between any of the computer(s) or communication device(s) 10, 30, 40, 50, and 60, as well as the Internet and/or the World Wide Web 20, can communicate with any other computer(s) or communication device(s) 10, 30, 40, 50, and 60, as well as the Internet and/or the World Wide Web 20, in a bi-directional manner.

In a preferred embodiment, the central processing computer(s) 10, the Internet and/or the World Wide Web 20, the legal services provider computer(s) 30, the law enforcement computer(s) 40, the user communication device(s) 50, and the third party communication device(s) 60, can communicate with one another, and/or be linked to one another, over the Internet and/or the World Wide Web, and/or a communication network, a telecommunication network, a telephone network, a line-connected network, and/or a wireless communication network. Each of the respective computers or communication devices 10, 30, 40, 50, and 60, and/or the Internet and/or the World Wide Web 20, can be linked with any other computer or computers or communication device or communication devices directly or indirectly with one another so as to facilitate a direct or indirect bi-directional communication said respective computers or networks. Communications between each of the respective computers or communication devices 10, 30, 40, 50, or 60, and/or the Internet and/or the World Wide Web 20, can also involve an e-mail server or e-mail servers in those instances when e-mails are described as being used to transmit or send any of the information, signals, messages, reports, notification messages, or any other communications, described herein, by or between any of the respective computers or communication devices 10, 30, 40, 50, or 60, and/or the Internet and/or the World Wide Web 20, or when any of the information, signals, messages, reports, notification messages, or any other communications, described herein, are transmitted by and/or between any of the parties described herein and/or by or between any of the respective computers or communication devices 10, 30, 40, 50, or 60, and/or the Internet and/or the World Wide Web 20, or any other computers or communication devices, computer systems, communication network equipment, and/or server computers, etc., or any other devices used or needed in order to facilitate communications or the transmission of any of the herein-described information, signals, messages, reports, notification messages, or any other communications.

In the preferred embodiment, the apparatus 100 of the present invention is utilized on, and/or over, the Internet and/or the World Wide Web. The apparatus 100 of the present invention, in the preferred embodiment, can also utilize wireless Internet and/or World Wide Web services, equipment and/or devices. The central processing computer(s) 10, in the preferred embodiment, has a web site or web sites associated therewith. Each of the legal services provider computers 30, the law enforcement computers 40, and/or the third party communication devices 60 can also have a web site or web sites associated with same.

Although the Internet and/or the World Wide Web is the preferred communication system, network, and/or medium, utilized, the present invention, in any and/or all of the embodiments described herein, can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

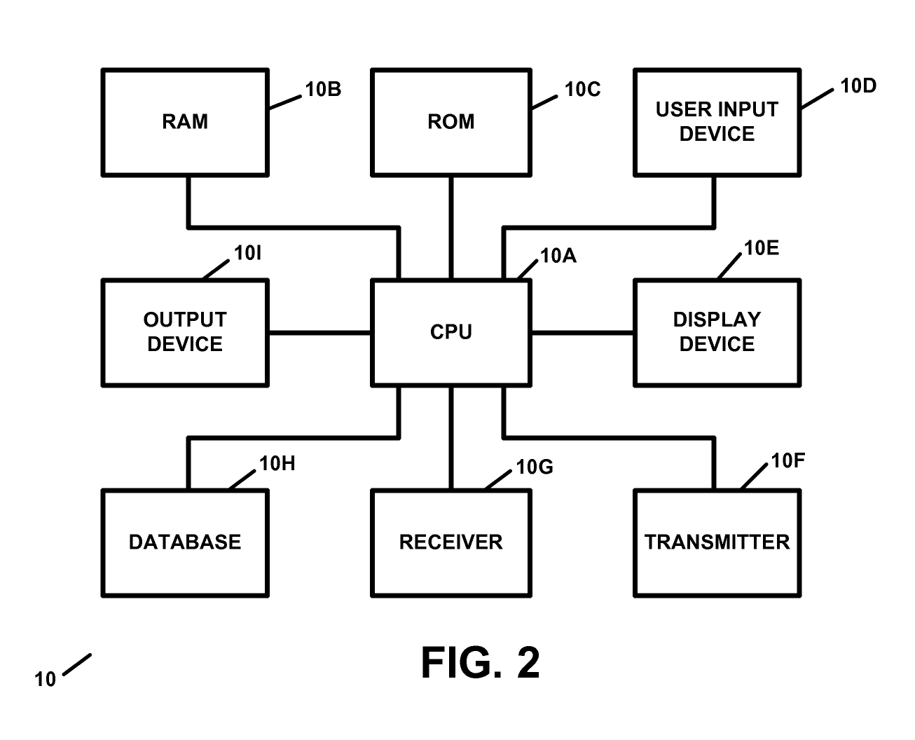

FIG. 2 illustrates a preferred embodiment of the central processing computer 10 of FIG. 1, in block diagram form. The central processing computer 10, in the preferred embodiment, is a network computer or computer system, or any other communication device which can provide the functionality of, and which can be utilized as a central processing computer 10 such as an Internet server computer and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) (RAM) 10B and a read only memory device(s) (ROM) 10C, each of which is connected to the CPU 10A, and a user input device 10D, for entering data and/or commands into the central processing computer 10, which includes any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise which can be utilized for inputting and/or entering data and/or information, of any kind or type pertinent to the operation of the apparatus 100 of the present invention, into the central processing computer 10. The input devices 10D are also connected to or with, or linked to or with, the CPU 10A. The central processing computer 10 also includes a display device 10E for displaying data and/or information to a user or operator.

The central processing computer 10 also includes a transmitter(s) 10F, for transmitting signals and/or data and/or information to any one or more of the Internet and/or the World Wide Web 20, the legal services provider computers 30, the law enforcement computers 40, the user communication devices 50, and/or the third party communication devices 60, described herein, and/or to any other central processing computers 10.

The central processing computer 10 also includes a receiver(s) 10G, for receiving signals and/or data and/or information from any one or more of the Internet and/or the World Wide Web 20, the legal services provider computers 30, the law enforcement computers 40, the user communication devices 50, and/or the third party communication devices 60, described herein, and/or to any other central processing computers 10.

The central processing computer 10 also includes a database(s) 10H, which is also connected to or linked with the CPU 10A, which can contain any and/or all of the data and/or information needed for performing any and/or all of the functions and/or functionality described herein as being performed by the apparatus 100 and method of the present invention. In a preferred embodiment, the database 10H contains or includes data and/or information regarding the individual(s), user(s), member(s), or other entity or entities (hereinafter “user”), who or which utilize the apparatus 100, the central processing computer 10, and/or the user communication device 50, including, but not limited to, his, her, or its, name, address, telephone number(s), cellular telephone number(s), wireless telephone number(s), personal communication device telephone number(s), e-mail address(es), text message number(s) or information, SMS message(s) or information, account information, account information regarding accounts of parents, children, spouse, siblings, and/or any other relatives, of the user, and/or friends of the user, or any other individual or entity of interest to the user. The database 10H can also contain or include data and/or information regarding any of the herein-described search requests, search reports or search report results, messages, comments, or postings obtained from search requests, search report messages, response messages, messages to content providers, rebuttal messages, cease and desist messages, legal messages, legal letters or correspondence, information regarding legal proceedings, lawsuits, settlement agreements, and/or any other reports or messages described herein as being generated by the herein-described apparatus 100, by the central processing computer(s) 10, by the legal services provider computer(s) 30, the law enforcement computer(s) 40, by the user communication device 50, by any other user communication device(s) 50, or by the third party communication device(s) 60.

The database 10H can also contain or include any other data and/or information described herein as being stored in the database or databases of any and/or all of the legal services provider computers 30, the law enforcement computers 40, the user communication devices 50, and/or the third party communication devices 60, described herein, and/or of any other central processing computers 10. The database can also include any data, information, and/or software, needed or desired for performing any and all of the processing routines, functions, and/or functionality, described herein as being performed by the apparatus 100 of the present invention, and/or by the central processing computer 10 and/or by any of the legal services provider computers 30, the law enforcement computers 40, the user communication devices 50, and/or the third party communication devices 60, described herein, and/or of any other central processing computers 10.

In the preferred embodiment, the database 10H can contain and/or include, for each individual, user, member, subscriber, or entity, who or which utilizes the apparatus 100, any and/or all search requests, search frequencies, searches, search words or searching information, search, search reports generated from searches, search reports generated by search engines or other searching mechanisms, intelligent agents, or web searching software routines or applications, content found or uncovered from searches, names or companies, operators, or websites, associated with computers or computer systems from which content is found or retrieved, the name and address, and/or officers or managers of the companies, operators, or websites, associated with the computer(s) in which content was found or retrieved, pre-selected or other messages selected or provided by each individual, user, member, subscriber, or entity, which are to be sent to companies, operators, or websites, associated with the computer(s) in which content was found or retrieved, information regarding responses to any messages sent to companies, operators, or websites, associated with the computer(s) in which content was found or retrieved, information regarding a lack of a response to any messages sent to companies, operators, or websites, associated with the computer(s) in which content was found or retrieved, letters, e-mails, text messages, or other correspondence, from attorneys, agents, or representatives, of any of the individuals, users, members, subscribers, or entities, to any of the companies, operators, or websites, associated with the computer(s) in which content was found or retrieved, and/or any responses to said letters, e-mails, text messages, or other correspondence, from the companies, operators, or websites, associated with the computer(s) in which content was found or retrieved or their attorneys, agents, or representatives.

The database 10H can also contain or include information regarding any lawsuits or legal actions or proceedings filed by any of the herein-described individuals, users, members, subscribers, or entities, against any of the companies, operators, or websites, associated with the computer(s) in which content was found or retrieved, and/or any other information which can be utilized by the central processing computer 10 in performing any and/or of the functions, processing routines, or functionality described herein as being performed by the apparatus 100 and/or by the central processing computer 10.

The database 10H can also contain and/or include any and/or all data and/or information which can be stored in or which can be accessed by or utilized by any commercial search engines or any other search engines which can be utilized in connection with the Internet and/or the World Wide Web.

The database 10H can also contain and/or include any and/or all data and/or information which can be stored in the respective databases of any of the herein-described legal services provider computers 30, law enforcement computers 40, user communication devices 50, and/or third party communication devices 60, described herein, and/or in the databases 10H of any other central processing computers 10.

The database 10H can also contain or include any necessary Internet domain names registries, website registries, domain name registries, and/or any other information which provide the names, addresses, e-mail address, telephone numbers, and/or any other contact information for computer or website and/or domain name utilized on or over the Internet and/or the World Wide Web, and/or the name and identity of the owner and/or operator of any domain name, computer or website, and/or any other information for allowing the central processing computer 10 to identify the owner or operator of a computer or website on which any of the herein-described comments, statements, or postings, are found.

The database 10H can also contain or include, for any and/or all users, individuals, members, subscribers, or entities, who or which utilize the apparatus 100 and method of the present invention, any and/or all of the herein-described search requests, search engine search request reports, search reports, alerts, alert messages, notification messages, search results, comments, statements, or postings, user instructions, response messages, rebuttal messages, cease and desist messages, response messages, rebuttal messages, and/or cease and desist messages, and/or any other messages, and/or any responses by any of the owners or operators of any computers or websites, and/or any other information described herein as being processed by, generated by, transmitted by, or otherwise provided by, the apparatus 100, the central processing computer 10, and/or the user communication device 50, and/or any of the legal services providers computers 30, the law enforcement computers 40, and/or the third party computers 60, and/or any data and/or information regarding same, and/or any other information described herein as being processed or generated by the apparatus 100 of the present invention and/or the central processing computer 10, and/or any other data and/or information needed or desired for performing any of the processing routines and/or any of the functions and/or functionality described herein as being performed or provided by the apparatus 100 and method of the present invention.

The database 10H can also contain or include any and/or all data and/or information and/or any software programs, routines, and/or software applications or “apps”, needed or desired for performing any and/or of the processing routines, functions, and/or functionality, described herein as being provided by or performed by the apparatus 100 of the present invention and/or by the central processing computer 10. The database 10H can also contain or include any and/or all data and/or information and/or any software programs, routines, and/or software applications or “apps”, needed or desired for performing any and/or of the processing routines, functions, and/or functionality, described herein as being provided by the user communication device 50, with such data and/or information and/or software applications or “apps”, being downloadable to the user communication device 50 if and when needed or desired.

In a preferred embodiment, the database 10H can also contain or include any data and/or information needed or desired for performing any and all of the processing routines, functions, and/or functionality, described herein as being performed by the apparatus 100, and/or the central processing computer 10, and/or any of the legal services provider computers 30, the law enforcement computers 40, the user communication devices 50, and/or the third party communication devices 60, described herein as being utilized in connection with the apparatus 100 of the present invention.

The central processing computer 10 also includes an output device 10I, which is also connected to the CPU 10A, for outputting any data and/or information, described herein. In the preferred embodiment, the output device 10I can be a printer, a display, a transmitter, a modem, and/or any other device which can be used to output data or information.

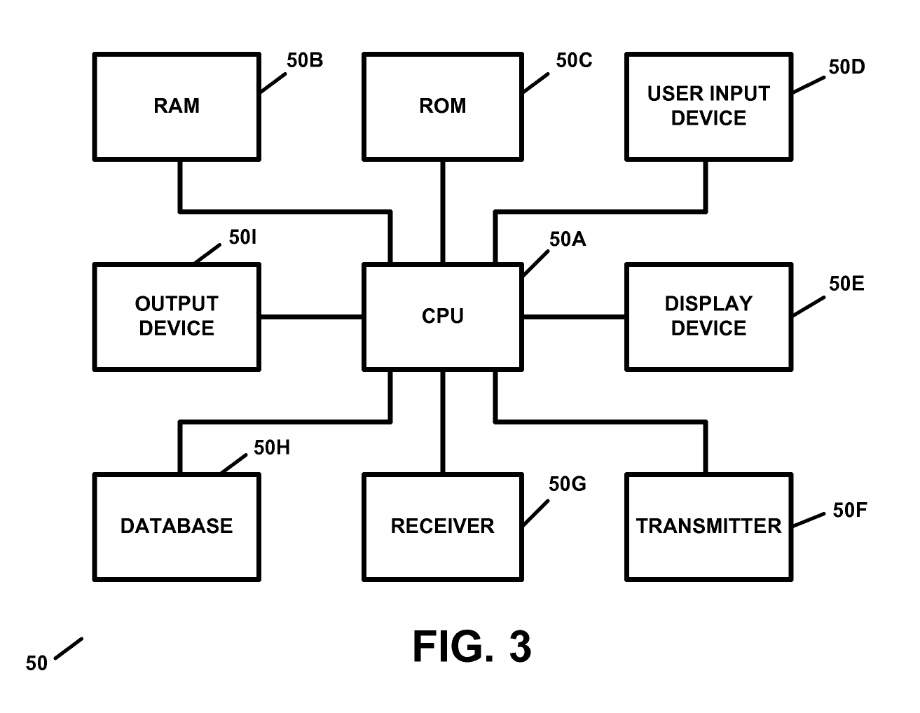

FIG. 3 illustrates the user communication device 50 of FIG. 1, in block diagram form. With reference to FIG. 3, the user communication device 50 includes a central processing unit or CPU 50A, which in the preferred embodiment, is a microprocessor. The CPU 50A may also be a microcomputer, a minicomputer, a macro-computer, and/or a mainframe computer, depending upon the application.

The user communication device 50 also includes a random access memory device(s) (RAM) 50B and a read only memory device(s) (ROM) 50C, each of which is connected to the CPU 50A, and a user input device 50D, for entering data and/or commands into the user communication device 50, which includes any one or more of a keyboard, a scanner, a user pointing device, such as, for example, a mouse, a touch pad, a touch screen, and/or an audio input device and/or a video input device, a microphone or audio recording device, a camera or a video recording device, and/or any device, electronic and/or otherwise which can be utilized for inputting and/or entering data and/or information, of any kind or type pertinent to the operation of the apparatus 100 of the present invention, into the user communication device 50. The input device 50D can also be any other input device(s) which are or can be utilized with or in connection with any of the user communication devices 50 described herein as being utilized in connection with the apparatus 100 of the present invention. The input devices 50D are also connected to or with, or linked to or with, the CPU 50A. The user communication device 50 also includes a display device 50E for displaying data and/or information to a user or operator.

The user communication device 50 also includes a transmitter(s) 50F, for transmitting signals and/or data and/or information to any one or more of the central processing computer(s) 10, the Internet and/or the World Wide Web 20, the legal services provider computer(s) 30, the law enforcement computer(s) 40, any other user communication device(s) 50, and the third party communication device(s) 60, described herein.

The user communication device 50 also includes a receiver(s) 50G, for receiving signals and/or data and/or information from any one or more of the central processing computer(s) 10, the Internet and/or the World Wide Web 20, the legal services provider computer(s) 30, the law enforcement computer(s) 40, any other user communication device(s) 50, and the third party communication device(s) 60, described herein.

The user communication device 50 also includes a database(s) 50H, which is also connected to or linked with the CPU 50A, which can contain any and/or all of the data and/or information needed for performing any and/or all of the functions and/or functionality described herein as being performed by the apparatus 100 and method of the present invention as well as any and/or all of the functions and/or functionality described herein as being performed by the user communication device 50.

In a preferred embodiment, the database 50H contains or includes data and/or information regarding the individual(s), user(s), member(s), or other entity or entities (hereinafter “user”), who or which utilize the apparatus 100, the central processing computer 10, and/or the user communication device 50, including, but not limited to, his, her, or its, name, address, telephone number(s), cellular telephone number(s), wireless telephone number(s), personal communication device telephone number(s), e-mail address(es), text message number(s) or information, SMS message(s) or information, account information, account information regarding accounts of parents, children, spouse, siblings, and/or any other relatives, of the user, and/or friends of the user, or any other individual or entity of interest to the user. The database 50H can also contain or include data and/or information regarding any of the herein-described search requests, search reports or search report results, messages, comments, or postings obtained from search requests, search report messages, response messages, messages to content providers, rebuttal messages, cease and desist messages, legal messages, legal letters or correspondence, information regarding legal proceedings, lawsuits, settlement agreements, and/or any other reports or messages described herein as being generated by the herein-described apparatus 100, by the central processing computer(s) 10, by the legal services provider computer(s) 30, the law enforcement computer(s) 40, by the user communication device 50, by any other user communication device(s) 50, or by the third party communication device(s) 60.

The database 50H can also contain or include any other data and/or information described herein as being stored in the database 10H of the central processing computer 10, as well as any data, information, and/or software, needed or desired for performing any and all of the processing routines, functions, and/or functionality, described herein as being performed by the apparatus 100 of the present invention, and/or by the central processing computer 10 and/or the user communication device 50.

The user communication device 50 also includes an output device 501, which is also connected to the CPU 50A, for outputting any data and/or information, described herein. In the preferred embodiment, the output device 501 can be a printer, a display, a transmitter, a modem, and/or any other device which can be used to output data or information.

In a preferred embodiment, the apparatus 100 and method of the present invention can be utilized in order to provide and/or to process information regarding, relating to, or involving, any type or kind of defamatory, derogatory, harassing, bullying, or other negative or offensive, comments, statements, or postings, made, disseminated, or posted, about any user, and/or any individual or any entity, on the Internet and/or the World Wide Web or on any computers or websites accessible via the Internet and/or the World Wide Web. In a preferred embodiment, the apparatus 100 and method of the present invention can be utilized in order to notify or to inform a user, individual, or entity, of comments, statements, or postings, which name or refer to the user, individual, or entity, and which contain any type or kind of defamatory, derogatory, harassing, bullying, or other negative or offensive, comments, or statements, about or regarding the user, individual or entity, or which can serve to harm or negatively impact upon the user's, individual's, or entity's, reputation, present the user, individual or entity, in a false light, harass or threaten the user, individual or entity, or otherwise ridicule or embarrass the user, individual or entity, or subject the user, individual or entity, to scorn in a public or private forum.

For the sake of simplicity, the terms “user” or “individual” can refer to any user, individual, member, subscriber, or entity, described herein who or which can utilize the apparatus 100 of the present invention or for whom the apparatus 100 of the present invention can be used.

In another preferred embodiment, the apparatus 100 of the present invention can be utilized be utilized to notify or inform a user or individual of comments, statements, or postings, which name or refer to a child, a parent, spouse, sibling, a relative, a friend, a client, of the user or individual, or any other person having a relationship with the user or individual and which contain any type or kind of defamatory, derogatory, harassing, bullying, or other negative or offensive, comments, or statements, about or regarding the child, parent, spouse, sibling, relative, friend, or client, of the user or individual or which can serve to harm or negatively impact upon the reputation of the child, parent, spouse, sibling, relative, friend, or client, present the child, parent, spouse, sibling, relative, friend, or client in a false light, harass or threaten the child, parent, spouse, sibling, relative, friend, or client, or otherwise ridicule or embarrass the child, parent, spouse, sibling, relative, friend, or client, or subject the child, parent, spouse, sibling, relative, friend, or client to scorn in a public or private forum.

In another preferred embodiment, the apparatus 100 of the present invention can be utilized to notify or inform an attorney, an agent, or a representative, of a user, individual, or entity, of comments, statements, or postings, which name or refer to the user, individual, or the entity, and which contain any type or kind of defamatory, derogatory, harassing, bullying, or other negative or offensive, comments or statements, about or regarding the user, individual, or entity, or which can serve to harm or negatively impact upon the reputation of the user, individual, or entity, present the user, individual, or entity, in a false light, harass or threaten the user, individual, or entity, or otherwise ridicule or embarrass the user, individual, or entity, or subject the individual or entity to scorn in a public or private forum.

In another preferred embodiment, the apparatus 100 and method of the present invention can be utilized to notify or inform an entity of comments, statements, or postings, which name or refer to the entity, or products, services, or activities, of the entity, and which contain any type or kind of defamatory, derogatory, harassing, bullying, or other negative or offensive, comments or statements or which can serve to harm or negatively impact upon the reputation of the entity, present the entity in a false light, harass or threaten the entity, or otherwise ridicule or embarrass the entity, or subject the entity to scorn in a public or private forum.

In a preferred embodiment, the apparatus 100 and method of the present invention can be programmed by any user, individual, or entity, or any attorney, agent, or representative, to detect the occurrence or posting of any of the herein-described comments, statements, or postings, which name or refer to the user, individual, or entity, and which contain any type or kind of defamatory, derogatory, harassing, bullying, or other negative or offensive, comments or statements or which can serve to harm or negatively impact upon the reputation of the user, individual, or entity, present the user, individual, or entity, in a false light, harass or threaten the user, individual, or entity, or otherwise ridicule or embarrass the user, individual, or entity, or subject the user, individual, or entity, to scorn in a public or private forum, and notify or inform the user, individual, or entity, or an attorney, agent, or representative, of same.

In another preferred embodiment, the apparatus 100 and method of the present invention can be utilized to allow a user, individual, or entity, or an attorney, agent, or representative, of same to respond to any of the herein-described comments, statements, or postings, which name or refer to the user, individual, or entity, and which contain any type or kind of the herein-described defamatory, derogatory, harassing, bullying, or other negative or offensive, comments or statements.

In another preferred embodiment, the apparatus 100 and method of the present invention can be utilized in order to allow any user, individual, or entity, or an attorney, agent, or representative, of same to respond to, to rebut, or to contact an owner or operator of any computer or website containing or posting, any of the herein-described comments, statements, or postings, which name or refer to the user, individual, or entity, and which contain any type or kind of the herein-described defamatory, derogatory, harassing, bullying, or other negative or offensive, comments, or statements.

The apparatus 100 and method of the present invention can also be utilized in another preferred embodiment, in order to record and store any/or information regarding any of the herein-described comments, statements, or postings, which name or refer to the user, individual, or entity, and which contain any type or kind of the herein-described defamatory, derogatory, harassing, bullying, or other negative or offensive, comments or statements, any searches uncovering same, any attempts or activities to have same removed, any attempts or activities to respond to or to rebut same, any referrals to any legal services provider(s), any referrals to any law enforcement agencies, bureaus, or entities, any referrals to any third parties, and/or any activities and/or correspondences sent to and/or received by any of the herein-described users, individuals, members, subscribers, entities, attorneys, agents, representatives, legal services providers, law enforcement agencies, bureaus, or entities, and/or third parties described herein.

In a preferred embodiment, the apparatus 100 and method of the present invention can be utilized in order to allow any of the herein-described users, individuals, members, subscribers, entities, or attorneys, agents, or representatives of same, in order to establish an account with the apparatus 100 and/or with the central processing computer 10 and/or to request and/or to program the central processing computer 10 and/or the apparatus 100 to continuously monitor the Internet and/or the World Wide Web in order to detect, and to report on, any occurrences or postings of any and/or all comments, statements, or postings, which name or refer to the user, individual, member, subscriber, or entity (hereinafter referred to as “user” for simplicity), and which contain any type or kind of the herein-described defamatory, derogatory, harassing, bullying, or other negative or offensive, comments or statements.

In a preferred embodiment, the user, or his, her, or its, attorney, agent, or representative, can request that search reports be generated by the central processing computer 10 which contain data and/or information regarding each detected occurrence or posting or any and/or all comments, statements, or postings, which name or refer to the user, the website or computer on which herein-described comments, statements, or postings, are or were found, the owner and/or operator of the computer or website, contact information regarding the owner and/or operator of the computer or website, including but not limited to name, address, telephone number, e-mail address or e-mail addresses, officers, directors, or members, including but not limited the names, telephone numbers, and e-mail addresses for each officer, director, or member, and/or any other information or contact information for the company and/or operator. In a preferred embodiment, the user, or his, her, or its attorney, agent, or representative, can also request that any and/or all search reports generated by the central processing computer 10 be transmitted to the user and/or to his, her, or its, attorney, agent, or representative.

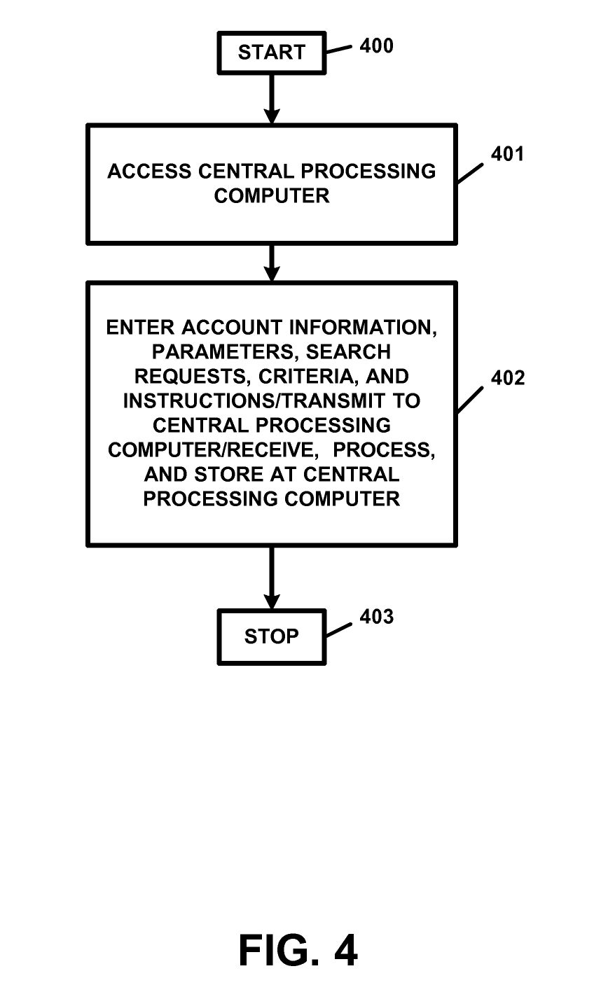

FIG. 4 illustrates a preferred embodiment method for utilizing the apparatus 100 of the present invention, in flow diagram form. With reference to FIG. 4, the operation of the apparatus 100 commences at step 400. At step 401, the user, or his, her, or its, attorney, agent, or representative, can access the central processing computer 10 via or using the user communication device 50. At step 402, if the user does not have an account with the central processing computer 10, then user, or his, her, or its, attorney, agent, or representative, can create or establish an account for the user. In a preferred embodiment, the account can be termed a “reputation protection account” or a “reputation security account”, or the account can be termed or referred to by any other name. Once the account has been established, or if the account already existed, the user, or his, her, or its, attorney, agent, or representative, at step 402, can also enter into the user communication device 50 and transmit to the central processing computer 10, any and/or all requests for searches to uncover or detect any occurrences or postings of any and/or all comments, statements, or postings, which name or refer to the user and which contain any type or kind of the herein-described defamatory, derogatory, harassing, bullying, or other negative or offensive, comments or statements.

At step 402, the user, or his, her, or its, attorney, agent, or representative, can also enter into the user communication device 50 and transmit to the central processing computer 10, any instructions, parameters, criteria, and/or any other information, for or regarding the formulation of any of the herein-described searches.

At step 402, the user, or his, her, or its, attorney, agent, or representative, can also enter into the user communication device 50 and transmit to the central processing computer 10, any search terms or words which should be included in any search requests, a name(s) or a person(s) which or who might be included in a search request(s), a word description of subject matter which can be included in a search request(s), names of individual or entities associated with past comments, statements, or postings, or any defamatory, derogatory, harassing, bullying, or other negative or offensive, comments or statements about the user or about any other individuals, people, groups, or entities, and/or any other information which can be used in the searches performed by the central processing computer 10.

At step 402, the user, or his, her, or its, attorney, agent, or representative, can also enter into the user communication device 50 and transmit to the central processing computer 10, any instructions regarding the user desired frequency for having any of the herein-described searches conducted. In a preferred embodiment, the user, or his, her, or its, attorney, agent, or representative, can select and/or instruct that searches be performed hourly, daily, every other day, weekly, bi-weekly, monthly, or at any other user-desired or user-selected time interval or frequency. At step 402, the user, or his, her, or its, attorney, agent, or representative, can also enter into the user communication device 50 and transmit to the central processing computer 10, any instructions regarding the mode and/or manner for being notified or informed of any of the herein-described detected occurrences or postings of any and/or all comments, statements, or postings, as well as the mode and/or manner for being provided with any messages regarding same, any messages regarding the availability of any search reports or other reports or messages regarding or relating to same, and any search reports, search report messages, or any other messages containing any and/or all information regarding or relating to the results of any of the herein-described searches.

In a preferred embodiment, alerts, alert messages, notification messages, search reports, search report messages, or any other messages or reports, can be utilized to transmit or to convey any of the herein-described information, regarding or relating to any of the herein-described detected occurrences or postings of any and/or all comments, statements, or postings, any messages regarding same, any messages regarding the availability of any search reports, search report messages, or other reports or messages regarding or relating to same, and any search reports or messages containing any and/or all information regarding or relating to the results of any of the herein-described searches. In a preferred embodiment, any of the herein-described alerts, alert messages, notification messages, search reports, search report messages, or any other messages or reports, can be, or can be contained in, an e-mail message, an instant messaging message, an SMS message, an electronic message or transmission of any kind or type, a pre-recorded telephone message, a pre-recorded voicemail message, or any other type, kind, or form, of message or report.

In a preferred embodiment, any of the herein-described alerts, alert messages, notification messages, search reports, search report messages, or any other messages or reports, can contain a link(s) or a hyperlink(s) to any of the computers or websites on which any comments, statements, or postings, are found, contained, or posted, a link(s) or a hyperlink(s) to any owner and/or operator of same, and/or a link(s) or a hyperlink(s) to any of the herein-described legal services provider computer(s) 30, law enforcement computer(s) 40, the third party communication device(s) 60, or any other user communication device(s) 50, as well as to an computer or communication device utilized by or associated with the user, or his, her, or its, attorney, agent, or representative.

At step 402, the central processing computer 10 can receive, process, and store the information and/or instructions transmitted from the user communication device 50. At step 402, the central processing computer 10 can, if an account needs to be established, establish the account. At step 402, the central processing computer 10 can also process any and/or all information and/or instructions regarding the account so that the central processing computer 10 can be programmed to perform any and/or all requested or instructed searches, operations, and/or functions. Thereafter, the operation of the apparatus 100 will cease at step 403.

In another preferred embodiment of FIG. 4, if a user already has an account, the step of establishing an account can be dispensed with and the user, or his, her, or its, attorney, agent, or representative, can access the central processing computer 10 and can, at step 402, enter any new or additional requests or instructions or make changes or revisions to any previous request or instructions.

In another preferred embodiment, the apparatus 100 of the present invention can perform searches for a user, and upon detecting any occurrence or posting or any and/or all comments, statements, or postings, which name or refer to the user and which contain any type or kind of the herein-described defamatory, derogatory, harassing, bullying, or other negative or offensive, comments or statements, can generate any one or more of any of the herein-described alerts, alert messages, or notification messages, and transmit same to the user communication device 50 associated with or utilized by the user. In a preferred embodiment, the apparatus 100 and/or the central processing computer 10 can also generate any of the herein-described search reports, search report messages, or any other messages or reports and can also transmit same to the user communication device 50 automatically and/or in response to the user requesting same via the user communication device 50.

In another preferred embodiment, the apparatus 100 and/or the central processing computer 10 can be programmed to, or can respond to a user instruction to, transmit a correspondence or a letter, the content and/or subject matter of which can be provided by the user or by the user's attorney, agent, or representative, or which can be selected by the user from among a number of prepared correspondence forms or letter forms provided by, and/or stored in the database 10H of, the central processing computer 10, to any of the owners or operators of any computers or websites on which the offending comments, statements, or postings, appear or are posted which can inform the respective owner or operator of the computer or website of the existence of the offending comment, statement, or posting, and/or which can include a request or a demand that the offending comment, statement, or posting, be removed from the computer or website.

In the preferred embodiment, the apparatus 100 and./or the central processing computer 10 can also be programmed to, or can respond to a user instruction to, transmit rebuttal messages or response messages, for posting on the computers or websites on which the offending comments, statements, or postings, appear or are posted. In another preferred embodiment, the apparatus 100 and./or the central processing computer 10 can also programmed to, or can respond to a user instruction to, transmit rebuttal messages or response messages to the computers or websites on which the offending comments, statements, or postings, appear or are posted, or to the owners and operators of same. Any of the rebuttal messages or response messages described herein can be provided or dictated by the user or can be selected from among prepared rebuttal messages or response messages provided by, and/or stored in, the database 10H of the central processing computer 10.

In a preferred embodiment, any of the herein-described searches for a user, detected occurrences or postings of any and/or all comments, statements, or postings, detected for found, and/or any of the herein-described alerts, alert messages, or notification messages, search reports, search report messages, or any other messages or reports, and/or any of the herein-described correspondences or letters, rebuttal messages and/or response messages, can be stored in the database 10H of the central processing computer 10 for later retrieval and/or use in any appropriate manner. In a preferred embodiment, the apparatus 100 can be utilized to search for comments, statements, or postings which can either name the user, or name an individual or entity, such as, but not limited to a parent, spouse, child, sibling, or any other relative, or a client or customer, or any other individual or entity, for whom the user may have an interest in protecting from any type or kind of the herein-described defamatory, derogatory, harassing, bullying, or other negative or offensive, comments or statements, or any other unwanted comments, statements, or postings.

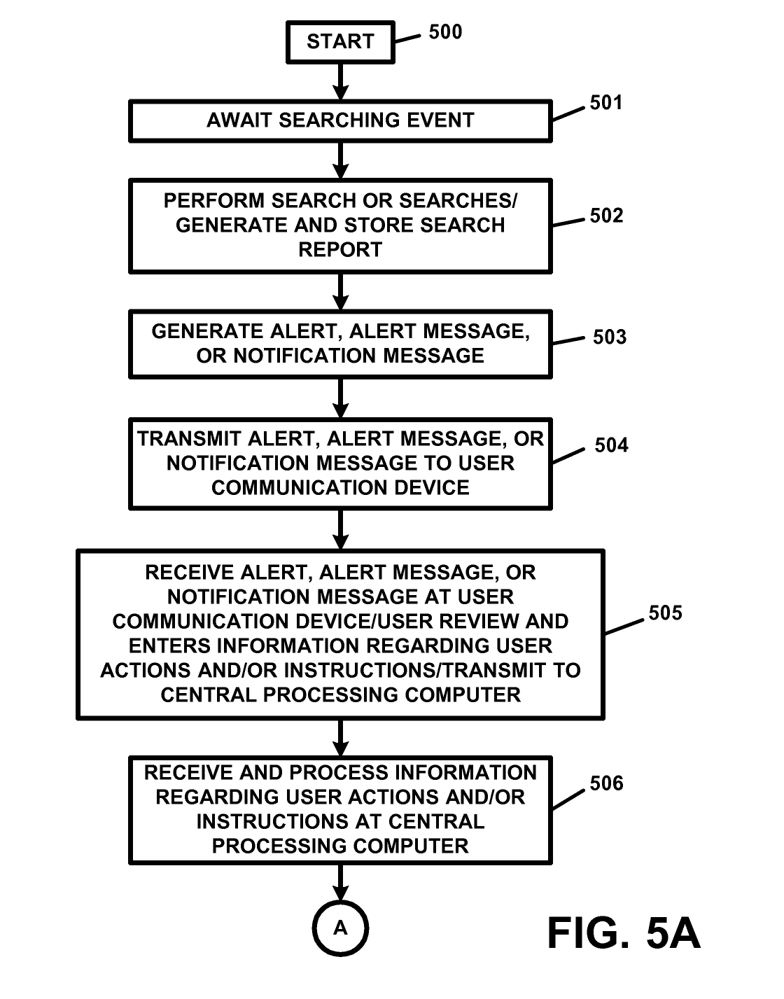

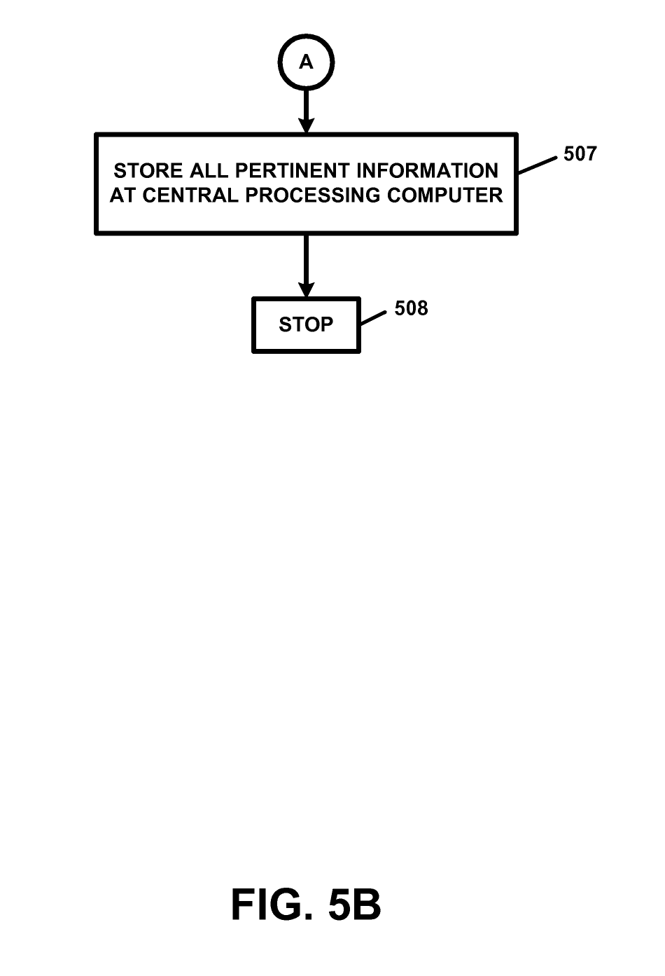

FIGS. 5A and 5B illustrates another preferred embodiment method for utilizing the apparatus 100 of the present invention, in flow diagram form. With reference to FIGS. 5A and 5B, the operation of the apparatus 100 commences at step 500. At step 501, the central processing computer 10, which, in a preferred embodiment, had been previously programmed for performing searches for a user, can await the occurrence of a searching event. The searching event can occur at a pre-determined time interval or time intervals previously selected by the user. In a preferred embodiment, the searching event can be programmed to occur every hour. In another preferred embodiment, the searching event can be programmed to occur daily, every other day, weekly, bi-weekly, or monthly, or at any other frequency.

Upon the occurrence of a scheduled searching event, the operation of the apparatus 100 will proceed to step 502, and the central processing computer 10 will perform all of the requested searches on or of the Internet and/or the World Wide Web using any and/or all available Internet search engines. In a preferred embodiment, the searches can be performed on any and/or all public networks or websites, private networks or websites, and/or social networking websites, and can be performed on public information as well as information contained on or in private networks.

In a preferred embodiment, each search can be formulated to search for any comments, statements, or postings, which name or refer to the user, or any individual or entity for whom the user desires the search to be performed, and which contain any type or kind of defamatory, derogatory, harassing, bullying, or other negative or offensive, comments or statements.

At step 502, the central processing computer 10 will, for each search request, perform a search of the Internet and/or the World Wide Web using each available Internet search engine, and can generate, for each Internet search engine utilized, a search engine search request report containing the results obtained for all searches performed pursuant to a search request using the Internet search engine. At step 502, the central processing computer 10 will perform all searches pursuant to all search requests using any and/or all available Internet search engines, and will generate all corresponding search engine search request reports for all search requests and for all searches pursuant to same performed using all of the available Internet search engines. At step 502, the central processing computer 10 will generate a search report containing all of the search results obtained for all searches performed using any and/or all available Internet search engines for all of the search requests. The search report will contain all detected or discovered comments, statements, or postings, which name or refer to the user, or any individual or entity for whom the user desires the search to be performed, and which contain any type or kind of defamatory, derogatory, harassing, bullying, or other negative or offensive, comments or statements.

In a preferred embodiment, the search report generated at step 502 can contain, for each detected comment, statement, or posting, a link(s) or hyperlink(s) to any computer(s) or website(s), and/or to any owner or operator of same, associated with each detected comment, statement, or posting, a link(s) or hyperlink(s), a link(s) or a hyperlink(s) to an officer, attorney, or other individual or entity, associated with the computer(s), the website(s)), and/or to any owner or operator of same, a link(s) or a hyperlink(s) to the central processing computer 10 and to a link(s) or hyperlink(s) for instructing the central processing computer 10 to either transmit to the owner or operator of the computer or website containing the respective comment, statement, or posting, a message identifying the comment, statement, or posting, and demanding same to be removed or deleted, or transmit to the owner or operator of the computer or website containing the respective comment, statement, or posting, a message identifying the comment, statement, or posting, and containing a response message to same or a rebuttal message to same and requesting or demanding that the response message or the rebuttal message be posted to respond to the comment, statement, or posting. In a preferred embodiment, any response message or rebuttal message can be prepared beforehand and can be stored and/or retrieved in or from the database 10H or same can be prepared by the user using the user communication device 50, at that time or in real-time, and can be transmitted to the central processing computer 10 along with the respective instruction.

The search report can also contain, for each detected comment, statement, or posting, a link(s) or hyperlink(s) to one or more of any of the herein-described legal services provider computers 30, law enforcement computers 40, other user communication devices 50, or third party communication devices 60, and/or other central processing computers 10. In this regard, a user can report and/or forward the respective comment, statement, or posting, to a respective attorney, law enforcement agency, another user, or a third party.

At step 502, the central processing computer 10 will store each and every search report in the database 10H of the central processing computer 10. At step 502, the central processing computer 10 can also create a file for each computer or website, or owner or operator of same, in which any comments, statements, or postings, which name or refer to the user and which contain any type or kind of the herein-described defamatory, derogatory, harassing, bullying, or other negative or offensive, comments or statements, are found to exist.

At step 503, the central processing computer 10 will generate an alert, an alert message, or a notification message, containing information for notifying or informing the user of or regarding any detected occurrence or occurrences of any of the herein-described detected comments, statements, or postings, and/or the generation and availability of the search report. At step 503, the alert, alert message, or notification message, in the preferred embodiment, can contain or have attached thereto the search report generated at step 502 and/or can also have a link(s) or hyperlink(s) to the search report and/or to any other previously generated search report or search reports.

At step 504, the central processing computer 10 can transmit the alert, alert message, or notification message, along with the attached search report, to the user communication device 50. At step 504, the central processing computer 10 can also, pursuant to previously provided instructions, also transmit the alert, alert message, or notification message, along with the attached search report, to an legal services provider computer 30 associated with or used by an attorney, agent, or representative, of the user, to a law enforcement computer 40 associated with or used by a law enforcement agency previously selected by the user, to another user computer 50 associated with or used by another user previously selected by the user to receive same, and/or to a third party communication device 60 associated with or used by a previously selected third party.

At step 505, the user communication device 50 can receive the alert, alert message, or notification message. At step 505, the user can access and review the alert, alert message, or notification message, and can access and review the search report. At step 505, the user can also utilize any of the information, link(s), or hyperlinks, contained in the search report in order to review the results contained therein, including any and/or all of the herein-described comments, statements, or postings, which name the user, or other individual or entity. At step 505, the user can also utilize any information, link(s), or hyperlink(s) contained in the search report in order to perform any task or function, or to instruct the central processing computer 10 to perform any task or function for or on behalf of the user. For example, at step 505, the user can review any and/or all of the herein-described comments, statements, or postings in the search report, and/or the user can contact the owner or operator of a computer or website posting a comment, statement, or posting, and/or transmit a message, a response message, a rebuttal message, a cease and desist message, or a message demanding that the owner or operator of a computer or website, posting a comment, statement, or posting, remove or delete same from it's computer or website. At step 505, the user can also contact an attorney, agent, or representative, of the owner or operator of a computer or website posting a comment, statement, or posting, and/or transmit a message, a response message, a rebuttal message, a cease and desist message, or a message demanding that the owner or operator of a computer or website, posting a comment, statement, or posting, remove or delete same from it's computer or website.

At step 505, the user can also instruct the central processing computer 10 to contact the owner or operator of a computer or website posting a comment, statement, or posting, and/or transmit a message, a response message, a rebuttal message, a cease and desist message, or a message demanding that the owner or operator of a computer or website, posting a comment, statement, or posting, remove or delete same from it's computer or website. At step 505, the user can also instruct the central processing computer 10 to contact an attorney, agent, or representative, of the owner or operator of a computer or website posting a comment, statement, or posting, and/or transmit a message, a response message, a rebuttal message, a cease and desist message, or a message demanding that the owner or operator of a computer or website, posting a comment, statement, or posting, remove or delete same from it's computer or website.

At step 505, the user can also select from among stored response messages, rebuttal messages, cease and desist messages, or messages demanding that a comment, statement, or posting, be removed or deleted from a computer or website, a message or messages which the user wants to transmit, or have the central processing computer 10 transmit, to an owner or operator of a computer or website or to a computer or communication device associated with the owner or operator. At step 505, the user can also prepare and transmit a response message, a rebuttal message, a cease and desist message, or a message demanding that a comment, statement, or posting, be removed or deleted from a computer or website, to the central processing computer 10, or to an owner or operator of a computer or website or to a computer or communication device associated with the owner or operator. The user can also instruct the central processing computer 10 to transmit the response message, rebuttal message, cease and desist message, or message demanding that a comment, statement, or posting, be removed or deleted from a computer or website, to an owner or operator of a computer or website or to a computer or communication device associated therewith.

At step 505, the user can also access any computer or website which contains a detected comment, statement, or posting, described herein and post a response message, a rebuttal message in response to, in reply to, or to counter, any detected comment, statement, or posting.

At step 505, the user can also access a computer or website containing a detected comment, statement, or posting, and post a response message, a rebuttal message, a cease and desist message, a cease and desist message directed to the individual responsible for posting a comment, statement, or posting, or any other comment countering or providing the user's position or response to or regarding a comment, statement, or posting. In a situation where an owner or operator of a computer or website can provide the user with the ability to remove, delete, or expunge, a detected comment, statement, or posting, the user, at step 505, can access the computer or website using the user communication device 50 either directly, or via a link or hyperlink in the search report, and remove, delete, or expunge, the detected comment, statement, or posting.

At step 505, the user can also forward the alert, alert message, or notification message, and/or the search report, and any and/or off or the comments, statements, or postings, contained therein, to any one or more of any of the herein-described legal services provider computers 30, law enforcement computers 40, other user communication devices 50, or third party communication devices 60, and/or other central processing computers 10, so as to report same to any of the users, individuals, or entities associated with any of the herein-described computers or communication devices 30, 40, 50, or 60. In this regard, at step 505, a user can report a comment(s), statement(s), or posting(s) to his or her attorney, agent, or representative, a law enforcement agency, a third party, or another user. At step 505, the user can also transmit any instructions and/or any messages prepared by the user to the central processing computer 10.

At step 506, the central processing computer 10 can receive and process any instructions and/or messages and can perform the tasks requested by or instructed by the user. At step, 506, the central processing computer 10 can also receive, store, and forward or transmit to the user communication device 50, any responses received from, or notes regarding any actions taken by, any owner or operator of any computer or website in response to any response message, rebuttal message, cease and desist message, or message demanding that a comment, statement, or posting, be removed or deleted from a computer or website which was transmitted to the owner or operator. At step, 506, the central processing computer 10 can also transmit to any one or more of any of the herein-described legal services provider computers 30, law enforcement computers 40, any other user communication devices 50, or third party communication devices 60, and/or other central processing computers 10, any responses received from, or notes regarding any actions taken by, any owner or operator of any computer or website in response to any response message, rebuttal message, cease and desist message, or message demanding that a comment, statement, or posting, be removed or deleted from a computer or website which was transmitted to the owner or operator.

At step 507, the central processing computer 10, can store in the database 10H, any of the herein-described and generated alerts, alert messages, notification messages, and search reports, any information or instructions received from the user, as well as any information regarding any of the actions taken by the central processing computer 10 for or on behalf of the user and any responses received from, or notes regarding any actions taken by, any owner or operator of any computer or website in response to any response message, rebuttal message, cease and desist message, or message demanding that a comment, statement, or posting, be removed or deleted from a computer or website which was transmitted to the owner or operator.

At step 507, the central processing computer 10 can store in a file associated with any owner or operator of any computer or website, any of the herein-described information relating to that particular owner or operator. Thereafter, the operation of the apparatus 100 will cease at step 508.

In another preferred embodiment of FIGS. 5A and 5B as well as any and/or all of the embodiments described herein, the central processing computer 10 can also be programmed or pre-programmed to perform any of the tasks described herein which the user can or may instruct the central processing computer 10 to do on the user's behalf or pursuant to the user's instructions. For example, the central processing computer 10 can be programmed so that upon receiving and processing any search results for any search requests, or upon generating the search report, the alert, the alert message, or the notification message, the central processing computer 10 can, for any and/or all detected comments, statements or postings, to perform any task or function for or on behalf of the user, contact the owner or operator of a computer or website posting a comment, statement, or posting, and/or transmit a message, a response message, a rebuttal message, a cease and desist message, or a message demanding that the owner or operator of a computer or website remove or delete same from it's computer or website.

In a preferred embodiment of FIGS. 5A and 5B, any of the herein-described alerts, alert messages, notification messages, search reports, or any other messages or reports, can be, or can be contained in, an e-mail message, an instant messaging message, an SMS message, an electronic message or transmission of any kind or type, a pre-recorded telephone message, a pre-recorded voicemail message, or any other type, kind, or form, of message or report.

In another preferred embodiment of FIGS. 5A and 5B as well as any and/or all of the embodiments described herein, the central processing computer 10 can also be programmed or pre-programmed to transmit the alert, the alert message, or the notification message, and/or any search report and/or any detected comment(s), statement(s), or posting(s), to a legal services provider computer(s) 30 associated with or used by an attorney, agent, or representative, of the user, a law enforcement computer 40 associated with a law enforcement agency or bureau, any other user communication device 50 associated with or used by the user or any other user, or any third party communication device 60. In another preferred embodiment of FIGS. 5A and 5B as well as any and/or all of the embodiments described herein, the central processing computer 10 can also be programmed or pre-programmed to contact an attorney, agent, or representative, of the user and/or of the owner or operator of a computer or website posting a comment, statement, or posting, and/or transmit a message, a response message, a rebuttal message, a cease and desist message, or a message demanding that the owner or operator of a computer or website, posting a comment, statement, or posting, remove or delete same from it's computer or website.

In another preferred embodiment of FIGS. 5A and 5B as well as any and/or all of the embodiments described herein, the central processing computer 10 can also be programmed or pre-programmed to contact the owner or operator of a computer or website posting a comment, statement, or posting, and to transmit a message, a response message, a rebuttal message, a cease and desist message, or a message demanding that the owner or operator of a computer or website remove or delete same from it's computer or website. In another preferred embodiment of FIGS. 5A and 5B as well as any and/or all of the embodiments described herein, the central processing computer 10 can also be programmed or pre-programmed to automatically access as computer or website containing a detected comment, statement, or posting, and post a response message, a rebuttal message in response to, in reply to, or to counter, any detected comment, statement, or posting for or on behalf of the user.

In another preferred embodiment of FIGS. 5A and 5B as well as any and/or all of the embodiments described herein, the central processing computer 10 can also be programmed or pre-programmed to generate and/or to transmit a response message, rebuttal message, cease and desist message, or message demanding that a comment, statement, or posting, be removed or deleted from a computer or website, to an owner or operator of a computer or website or to a computer or communication device associated therewith.

In another preferred embodiment of FIGS. 5A and 5B as well as any and/or all of the embodiments described herein, the central processing computer 10 can also be programmed or pre-programmed to forward the alert, alert message, or notification message, and/or the search report, and any and/or off or the comments, statements, or postings, contained therein, to any one or more of any of the herein-described legal services provider computers 30, law enforcement computers 40, other user communication devices 50, or third party communication devices 60, and/or other central processing computers 10, so as to automatically report same to any of the users, individuals, or entities associated with any of the herein-described computers or communication devices 30, 40, 50, or 60.

In another preferred embodiment of FIGS. 5A and 5B, the central processing computer 10 and/or the apparatus 100 can be programmed or pre-programmed to access a computer or website containing a comment, statement, or posting, and post a response message, a rebuttal message, a cease and desist message, a cease and desist message directed to the individual responsible for posting a comment, statement, or posting, or any other comment countering or providing the user's position or response to or regarding a comment, statement, or posting. In a situation where an owner or operator of a computer or website can provide the central processing computer 10 with the ability to remove, delete, or expunge, a detected comment, statement, or posting, the central processing computer 10 can be programmed or pre-programmed to automatically access the computer or website and automatically remove, delete, or expunge, the detected comment, statement, or posting.

In another preferred embodiment, the apparatus 100 of FIGS. 5A and 5B can be utilized by a parent user to monitor any comments, statements, or postings, naming his or her child, and/or so as to be alerted to and/or so as to report instances of cyber-bullying or any other bullying activities. In another preferred embodiment, the apparatus 100 of FIGS. 5A and 5B can be utilized by any user to monitor any comments, statements, or postings, naming him or her, his or her spouse, relatives, friends, clients, suppliers, customers, or his or her business, so as to be alerted to and/or so as to report instances of defamation, libel, slander, harassment, criminal activity, product or trade disparagement, and/or any other bad acts by others.

In any and/or all of the embodiments described herein, the apparatus 100, the central processing computer 10, and/or the user communication device 50, can be programmed to automatically respond to, remove, delete, or expunge, any of the herein-described detected comments, statements, or postings and to record and store any information regarding the respective comments, statements, or postings, and the responses to, removal, deletion, or expunging, of same.

In any and/or all of the embodiments described herein, the search reports can contain information regarding, or a link to or a hyperlink to, any computer or website on which a detected comment, statement, or posting, has been found or is posted. In this manner the user can communicate directly with the computer or website via his or her user communication device 50 or otherwise.

In any and/or all of the embodiments described herein, data and/or information regarding, and dates and times of, any and/or all of the searches performed, searching events, and scheduled searching events, generation and/or transmission of any of the herein-described alerts, alert messages, notification messages, search reports, any task or function which an be performed with the apparatus 100 of the present invention, any transmission of or forwarding of any information described-herein and/or any search reports to any legal services provider computer 30, law enforcement computer 40, any other user communication devices 50, and/or third party computers 60, and/or any of the herein-described instructions, and/or any of the herein-described actions performed by the user(s) and/or by the central processing computer 10 for or on behalf of the user or pursuant to instructions, can be stored in the database 10H of the apparatus 100.

In any and/or all of the embodiments described herein, any and/or all of the search engine search request reports, search reports, alerts, alert messages, notification messages, search results, comments, statements, or postings, response messages, rebuttal messages, cease and desist messages, response messages, rebuttal messages, and/or cease and desist messages, and/or any other messages, and/or any responses by any of the owners or operators of any computers or websites, can be date-stamped and/or time-stamped and stored in the database 10H of the central processing computer 10 and/or in the database 50H of the user communication device 50.

In another preferred embodiment of FIGS. 5A and 5B, as well as any and/or all of the embodiments described herein, the central processing computer 10 can receive, store, and/or transmit, to the user communication device 50, to the legal services provider computers 30, to the law enforcement computers 40, to any other user communication devices 50, or to the third party communication devices 60, and/or to any other central processing computers 10, any of the herein-described response messages, rebuttal messages, and/or cease and desist messages, and/or any other messages, transmitted to the owners or operators of the computers or websites and/or any responses or replies or correspondence received from any owners or operators of the computers or websites.

In any an/or all of the embodiments described herein, any signals, data, information, messages, reports, or any other transmissions can be date-stamped and/or time-stamped.

The apparatus 100 and method of the present invention can be utilized in order to inform or to notify any of the herein-described users, individuals, members, subscribers, or entities of comments, statements, or postings, which name of refer to them and which contain any type or kind of the herein-described defamatory, derogatory, harassing, bullying, or other negative or offensive, comments or statements. The apparatus 100 and method of the present invention can also be utilized in order to inform or to notify any of the herein-described users, individuals, members, subscribers, or entities of comments, statements, or postings which names of refers to any individual, a child, a spouse, a relative, a friend, a business colleague, and/or any other individual or entity, for whom they are responsible for caring or for whom they choose to look after or care for, or for whom they choose to utilize the apparatus 100 of the present invention.

In any and/or all of the embodiments described herein, any and/or all of the herein-described search requests, search engine search request reports, search reports, alerts, alert messages, notification messages, search results, comments, statements, or postings, user instructions, response messages, rebuttal messages, cease and desist messages, response messages, rebuttal messages, and/or cease and desist messages, and/or any other messages, and/or any responses by any of the owners or operators of any computers or websites, can be date-stamped and/or time-stamped and/or can be stored in the database 10H of the central processing computer 10 and/or in the database 50H of the user communication device 50, and/or in any of the legal services provider computers 30, the law enforcement computers 40, any other user communication devices 50, or the third party communication devices 60, and can be utilized as evidence in any legal proceedings or legal actions or law suits involving any user and any owner or operator of any website or any individual or person who posts any of the herein-described comments, statements, or postings, which name of refer to the user, or any other individual or entity, and which contain any type or kind of the herein-described defamatory, derogatory, harassing, bullying, or other negative or offensive, comments or statements.

In any and/or all of the embodiments described herein, the user can also access the central processing computer 10 at any time in order to request new, additional, or modified search requests. In any and/or all of the embodiments described herein, the user can also access the central processing computer 10 at any time to access stored search requests, search engine search request reports, search reports, alerts, alert messages, notification messages, search results, comments, statements, or postings, user instructions, response messages, rebuttal messages, cease and desist messages, response messages, rebuttal messages, and/or cease and desist messages, and/or any other messages, and/or any responses by any of the owners or operators of any computers or websites.

In any and/or all of the embodiments described herein, the central processor can also store activity reports for any of the herein-described accounts. The activity reports can contain records, including date and/or time of same, for any and/or all activities or processing activities on or involving an account. The activity reports can also contain records regarding and of the herein-described search requests, search engine search request reports, search reports, alerts, alert messages, notification messages, search results, comments, statements, or postings, user instructions, response messages, rebuttal messages, cease and desist messages, response messages, rebuttal messages, and/or cease and desist messages, and/or any other messages, and/or any responses by any of the owners or operators of any computers or websites, including data and/or time of same, and any user(s), individual(s), member(s), subscriber(s), entity or entities, computer(s) or website(s), legal service provider(s), law enforcement agency or agencies, or third party or third parties, involved in same.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. A computer-implemented method, comprising:
storing, in a database or a memory device, information regarding a search request relating to an individual, wherein the search request contains information for performing a search of the Internet or the World Wide Web to detect or find comments, statements, or postings, which contain defamatory, derogatory, harassing, bullying, or other negative or offensive, comments, statements, or postings, about or regarding the individual;
processing, with a processing device or with a computer, information regarding the search request;
performing, with or using the processing device or with or using the computer and using the search request, a search of the Internet or the World Wide Web;
receiving, with a receiver, with the processing device, or with the computer, search results obtained from or regarding the search;
generating, with the processing device or with the computer, a search report containing results obtained from the search, wherein the search report contains information regarding at least one comment, statement, or posting, which contains a defamatory, a derogatory, a harassing, a bullying, or other negative or offensive, comment, statement, or posting, about or regarding the individual;
generating, with the processing device or with the computer, an alert, an alert message, or a notification message; and
transmitting, with or from a transmitter, with or from the processing device, or with or from the computer, the alert, the alert message, or the notification message, to a communication device associated with or used by the individual.

2. The computer-implemented method of claim 1, wherein the alert, the alert message, or the notification message, contains the search report or contains a link or a hyperlink to the search report.

3. The computer-implemented method of claim 1, wherein the communication device is a cellular telephone or a smart phone.

4. The computer-implemented method of claim 1, wherein the communication device is a personal digital assistant.

5. The computer-implemented method or claim 1, wherein the communication device is a personal computer, a laptop computer, a tablet computer, a tablet, or a television.

6. The computer-implemented method of claim 1, wherein the alert, the alert message, or the notification message, is transmitted as or in an e-mail message.

7. The computer-implemented method of claim 6, wherein the search report is attached to the alert, the alert message, or the notification message.

8. The computer-implemented method of claim 1, wherein the alert, the alert message, or the notification message, is transmitted as or in an instant messaging message.

9. The computer-implemented method of claim 1, wherein the search report contains a link or a hyperlink for allowing the individual to transmit or post a response message or a rebuttal message on a computer or a website on which the defamatory, the derogatory, the harassing, the bullying, or the other negative or offensive, comment, statement, or posting, is found or posted.

10. The computer-implemented method of claim 1, further comprising:
receiving regarding an instruction transmitted from the communication device;
processing the information regarding an instruction; and
performing an action instructed by the instruction.

11. The computer-implemented method of claim 10, wherein the information regarding and instruction contains information for instructing the processing device or the computer to transmit a message to a computer or a website on which the defamatory, the derogatory, the harassing, the bullying, or the other negative or offensive, comment, statement, or posting, is found, wherein the message contains a request to have the defamatory, the derogatory, the harassing, the bullying, or the other negative or offensive, comment, statement, or posting, removed, deleted or expunged from the computer or the website.

12. The computer-implemented method of claim 10, wherein the information regarding and instruction contains information for instructing the processing device or the computer to transmit a message to a computer or a website on which the defamatory, the derogatory, the harassing, the bullying, or the other negative or offensive, comment, statement, or posting, is found, wherein the message contains a response message or a rebuttal message in response to the defamatory, the derogatory, the harassing, the bullying, or the other negative or offensive, comment, statement, or posting, removed, deleted or expunged from the computer or the website.

13. The computer-implemented method of claim 10, wherein the information regarding and instruction contains information for instructing the processing device or the computer to transmit a message to a computer or a website on which the defamatory, the derogatory, the harassing, the bullying, or the other negative or offensive, comment, statement, or posting, is found, wherein the message contains a demand that the defamatory, the derogatory, the harassing, the bullying, or the other negative or offensive, comment, statement, or posting, removed, deleted or expunged from the computer or the website.

14. The computer-implemented method of claim 1, further comprising:
performing a plurality of searches, wherein the search report contains search results from a single search or from a plurality of searches.

15. The computer-implemented method of claim 1, wherein the search is performed using a plurality of Internet search engines.

16. The computer-implemented method of claim 1, further comprising;
transmitting the alert, the alert message, or the notification message, to a computer associated with an attorney or a legal services provider.

17. The computer-implemented method of claim 1, further comprising;
transmitting the alert, the alert message, or the notification message, to a computer associated with a law enforcement agency of bureau.

18. The computer-implemented method of claim 1, further comprising:
transmitting the alert, the alert message, or the notification message, to a computer associated with a third party.

19. The computer-implemented method of claim 1, wherein the search report contains information, a link, or a hyperlink, to a computer or a website on which the defamatory, the derogatory, the harassing, the bullying, or the other negative or offensive, comment, statement, or posting, is found or posted.

20. The computer-implemented method of claim 1, wherein the search report contains information, a link, or a hyperlink, to a computer associated with an attorney, a legal services provider, or a law enforcement agency or bureau.
